(19) United States
(12) Patent Application Publication
(10) Pub. No.: US 2026/0065149 A1
(43) Pub. Date: Mar. 5, 2026

(54) PREDICT DATA AND METADATA FOR NEW OR SCHEDULED JOURNAL ENTRIES APPLYING TO THE GENERAL OR SUB LEDGERS

(71) Applicant: Oracle International Corporation, Redwood Shores, CA (US)

(72) Inventors: John D. Clark, JR., Pepperell, MA (US); Varghese Mathew, Karnataka (IN); Thomas LeFebvre, Danbury, CT (US); Tim Gaumont, Mesa, AZ (US)

(73) Assignee: Oracle International Corporation, Redwood Shores, CA (US)

(21) Appl. No.: 19/181,981

(22) Filed: Apr. 17, 2025

Related U.S. Application Data
(60) Provisional application No. 63/691,239, filed on Sep. 5, 2024.

(51) Int. Cl. G06N 20/00

(52) U.S. Cl. CPC G06N 20/00

(57) ABSTRACT

Systems, methods, and computer-readable media are provided for using a first machine learning model to predict a first type of member data for a journal entry based on partial information of the journal entry, and using a second machine learning model to predict a second type of member data based on the first type of member data as predicted, optionally accounting for a confidence score of the first type of member data. Systems, methods, and computer-readable media are also provided for predicting one or more items of metadata for a journal entry and graphically marking the one or more items of metadata for review, distinguishing reviewed items from items yet to be reviewed.

### CROSS REFERENCE TO RELATED APPLICATION(S)

This application claims the benefit of U.S. Provisional Patent Application No. 63/691,239, filed on Sep. 5, 2024. The entire disclosure of the aforementioned application is incorporated by reference herein in its entirety for all purposes.

### BACKGROUND

In business management software, journals are useful tools for recording and tracking a wide range of transactions and activities within an organization. While they are often associated with financial transactions like sales, purchases, payments, and receipts, journals can also log non-financial events such as inventory movements, production schedules, or customer interactions. Each entry in a journal typically includes details such as the date of the transaction or event, involved accounts or entities, quantities or amounts, and a brief description. By capturing both financial and non-financial activities, journals help maintain accurate, complete, and up-to-date records, which are crucial for reporting, auditing, and operational management.

Journals are used in business management software to organize and categorize various transactions and events before they are further processed or analyzed. In the case of financial transactions, this involves identifying the appropriate accounts to be debited and credited, ensuring the accuracy of the accounting records. For non-financial transactions, journals might track metrics like inventory levels, project progress, or employee hours. Specialized journals, like sales journals or inventory journals, may be used to handle frequent or specific types of activities more efficiently.

### BRIEF SUMMARY

In some embodiments, a computer-implemented method includes using a guided machine learning process to determine individual values to be included for different items in a journal. In one embodiment, a computer-implemented method is provided for using a first machine learning model to predict a first type of member data for a journal entry based on partial information of the journal entry, and using a second machine learning model to predict a second type of member data based on the first type of member data as predicted, optionally accounting for a confidence score of the first type of member data. In the same or a different embodiment, a computer-implemented method is provided for predicting one or more items of metadata for a journal entry and graphically marking the one or more items of metadata for review, distinguishing reviewed items from items yet to be reviewed. In one embodiment, a machine learning (ML) model and algorithm is configured to determine if journal entries can be automatically approved, closed, and/or posted without human review. For example, the ML model may be trained on historical journal entries to determine patterns of factors associated with journal entries that were approved and patterns for journal entries that were rejected. In operation, the ML model may then predict whether a particular journal can be automatically approved and closed (i.e., posted), or whether it must be reviewed and approved by a manual process. In another embodiment, the prediction or determination may be performed within a confidence band where the highest confidence journal entries are automatically approved and/or closed, while lower confidence journal entries may be recommended for manual closing and/or posting.

In a particular embodiment, a computer-implemented method comprises training a first machine learning model to predict a first type of member data for journal entries based on partial information for historical journal entries and a second machine learning model to predict a second type of member data for journal entries based at least in part on the first type of member data after the first type of member data has been determined. The computer-implemented method further comprises accessing, from a data structure, a journal entry that records a particular partial information about an acknowledgement of an amount. The particular partial information may be missing a value for a first item of member data of the first type and may be missing a value for a second item of member data of the second type. The computer-implemented method further comprises using the first machine learning model to automatically generate a first particular value for the first item of member data of the first type based at least in part on the partial information. The computer-implemented method further comprises using the second machine learning model to automatically generate a second particular value for the second item of member data of the second type based at least in part on the first particular value and a confidence score for the first particular value. The computer-implemented method further comprises persisting, as part of the journal entry in the data structure, the first particular value for the first item of member data and the second particular value for the second item of member data.

In a further embodiment, the computer-implemented method further comprises determining the confidence score using the first machine learning model based at least in part on previous predicted items of data and a record of whether the previous predicted items of data were accepted. The confidence score may be indicative of a likelihood of the first particular value being accepted.

In the same or different embodiment, determining the confidence score is further based on the amount associated with the acknowledgement.

In another embodiment that extends the particular embodiment or any further embodiment, the computer-implemented method further comprises updating the confidence score based at least in part on accepting the first particular value, rejecting the first particular value, or modifying one or more items of member data in the journal entry. The computer-implemented method may further comprise using the second machine learning model to automatically update the second particular value based on the updated confidence score.

In another embodiment that extends the particular embodiment or any further embodiment, the computer-implemented method further comprises using the second machine learning model to automatically generate a third particular value for a third item of member data of the second type based at least in part on the updated confidence score.

In another embodiment that extends the particular embodiment or any further embodiment, the computer-implemented method further comprises causing display of a first graphical option to accept the first particular value for the first item of member data and a second graphical option to reject the first particular value for the first item of member data. In this embodiment, persisting the first particular value of the first item in the data structure as part of the journal entry is based on selection of the first graphical option to accept the first particular value.

In another embodiment that extends the particular embodiment or any further embodiment, the computer-implemented method further comprises causing display of a first graphical option to accept the second particular value for the second item of member data and a second graphical option to reject the second particular value for the second item of member data. In this embodiment, persisting the second particular value of the second item in the data structure as part of the journal entry is based on selection of the first graphical option to accept the second particular value.

In another embodiment, a computer-implemented method includes training a machine learning model to complete metadata of journal entries based on historical relationships between the metadata and partial information of the journal entries. The computer-implemented method further comprises accessing, from a data structure, a particular journal entry that records an amount, one or more source entities relating to the amount, and one or more target entities relating to the amount. The computer-implemented method further comprises using the machine learning model to automatically generate one or more items of metadata for the particular journal entry, the one or more items of metadata including a reviewer, an approver, or one or more categories of the particular journal entry. The computer-implemented method further comprises causing concurrent display of one or more graphical representations of the one or more items of metadata, including a particular graphical representation of a particular item of metadata, using a different color than a base color used for one or more other graphical representations of the amount, the one or more source entities, or the one or more target entities. The computer-implemented method further comprises causing display of a first graphical option to accept the particular item of the one or more items of metadata and a second graphical option to reject the particular item of the one or more items of metadata. The computer-implemented method further comprises in response to selection of the first graphical option to accept the particular item, automatically persisting the particular item as part of the particular journal entry in the data structure, and automatically changing color of a particular graphical representation of the one or more graphical representations to the base color.

In a further embodiment, the machine learning model is a first machine learning model and the computer-implemented method further comprises training a second machine learning model to predict member data for journal entries based at least in part on items of metadata. In this embodiment, the computer-implemented method further comprises using the second machine learning model to automatically generate one or more values for one or more items of member data for the particular journal entry based at least in part on the particular item of metadata predicted using the first machine learning model and a confidence score for the particular item of metadata.

In the same or different embodiment, the computer-implemented method further comprises determining the confidence score based at least in part on a quantity of pending journal entries having a particular value for the approver, the reviewer, or the one or more categories.

In some embodiments, a system is provided that includes one or more data processors and a non-transitory computer-readable storage medium containing instructions which, when executed on the one or more data processors, cause the one or more data processors to perform part or all of one or more methods disclosed herein.

In other embodiments, a computer-program product is provided that is tangibly embodied in a non-transitory machine-readable storage medium and that includes instructions configured to cause one or more data processors to perform part or all of one or more methods disclosed herein.

Cloud services, microservices, or other machine-hosted services may be offered that perform part or all of one or more methods disclosed herein. The machine-hosted services may be provided by a single machine, by a cluster of machines, or otherwise distributed across machines. The one or more machines may be configured to send and receive data, which may include instructions for performing the methods or results of performing the methods, via an application programming interface (API) or any other communication protocol.

In various embodiments, part or all of one or more methods disclosed herein may be performed by stored instructions such as a software application, computer program, or other software package installed in memory or other storage of a computing platform, such as an operating system, which provides access to physical or virtual computing resources. The operating system may provide access to physical or virtual resources of a mobile computing device, a laptop computing device, a desktop computing device, a server computing device, a container in a virtual machine on a computing device, or any other computing environment configured to execute stored instructions.

As used herein, the terms “first,” “second,” “third,” “fourth,” etc. are used as naming conventions to refer to separate items in a set of items. These naming conventions do not imply ordering unless such ordering is explicitly noted using language specific to ordering, such as “before” or “after,” or unless such ordering is required to attain the expressly recited functionality, such as generating an item and later accessing the generated item.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

Various embodiments are described hereinafter with reference to the figures. It should be noted that the figures are not drawn to scale and that the elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure.

FIG. 1A illustrates a flow chart of an example sequential machine learning process to determine individual values to be included for different items in a journal.

FIG. 1B illustrates a flow chart of another example guided machine learning process to determine individual values to be included for different items in a journal.

FIG. 2 illustrates a system diagram showing an example cloud infrastructure that generates journals automatically based on user actions and auto populates data and meta data fields.

FIG. 3 illustrates a sample intercompany financial report.

FIG. 4 shows an example interface showing a suggested journal entry that is automatically created in the platform for resolving a mismatch between two entities.

FIG. 5 shows an example interface showing an overview of the journals module including the newly created journal entry from the example in FIG. 4.

FIG. 6 shows a sample of a financial data sheet that may trigger the automatic generation of a financial journal.

FIG. 7 shows a sample of a financial journal format that may be created manually by a user or automatically using techniques described herein.

FIG. 8 depicts a simplified diagram of a distributed system for implementing certain aspects.

FIG. 9 is a simplified block diagram of one or more components of a system environment by which services provided by one or more components of an embodiment system may be offered as cloud services, in accordance with certain aspects.

FIG. 10 illustrates an example computer system that may be used to implement certain aspects.

### DETAILED DESCRIPTION

A description of using a guided machine learning process to determine individual values to be included for different items in a journal is provided in the following sections:
USING ARTIFICIAL INTELLIGENCE AND MACHINE LEARNING TO PREDICT THE CREATION OF JOURNAL ENTRIES IN BUSINESS SOFTWARE
CREATION OF A SPECIFIC BUSINESS JOURNAL ENTRY
USING ARTIFICIAL INTELLIGENCE AND MACHINE LEARNING TO AUTO POPULATE DATA AND METADATA FIELDS IN BUSINESS SOFTWARE.
TRACKING SEPARATELY REVIEWED ITEMS OF MEMBER DATA OF A JOURNAL ENTRY.
EXAMPLE OF AUTOMATED JOURNAL ENTRY
COMPUTER SYSTEM ARCHITECTURE

The steps described in individual sections may be started or completed in any order that supplies the information used as the steps are carried out. The functionality in separate sections may be started or completed in any order that supplies the information used as the functionality is carried out. Any step or item of functionality may be performed by a personal computer system, a cloud computer system, a local computer system, a remote computer system, a single computer system, a distributed computer system, or any other computer system that provides the processing, storage and connectivity resources used to carry out the step or item of functionality.

Journals, which have one or more “journal entries,” in business software serve as a foundational tool for recording and organizing various transactions and activities that occur within an organization. They are not limited to financial data but extend to a wide array of business processes, including inventory management, project tracking, customer interactions, and employee activities. A journal functions as a detailed log where entries may be ordered chronologically, capturing information such as dates, entities involved, quantities or amounts, and descriptions of the transaction or event. This detailed record-keeping promotes tracking and documentation of activities, providing a clear and comprehensive view of operations. Once the journal entries are verified, they can be posted to the general ledger, or in the case of non-financial transactions, to other relevant databases or reports. This systematic use of journals across different areas of the business supports comprehensive data management, informed decision-making, and overall organizational efficiency.

Businesses use journals in their software systems to maintain order and accuracy across different facets of their operations. For financial transactions, journals help in recording sales, purchases, payments, and receipts, which are crucial for maintaining accurate accounting records and preparing financial statements. However, in a broader context, journals also track non-financial activities like inventory movements, production schedules, or service delivery. By documenting these activities in a structured manner, businesses can monitor their operations more effectively, ensuring that resources are used efficiently and that processes are running smoothly.

Journals also play a role in supporting decision-making and strategic planning. The detailed records kept in journals allow managers to analyze trends, identify inefficiencies, and make informed decisions based on accurate and up-to-date information. For example, an inventory journal might reveal patterns in stock usage that help optimize inventory levels, while a project journal could track milestones and deadlines to ensure that projects stay on schedule. This level of insight is invaluable for businesses aiming to improve performance, reduce costs, and enhance customer satisfaction.

Moreover, journals are useful for ensuring compliance with regulatory requirements and for auditing purposes. Many industries have strict regulations regarding record-keeping, and journals provide the necessary documentation to meet these standards. In the event of an audit, journals offer a clear and organized record of transactions and activities, making it easier to demonstrate compliance and address any discrepancies. Whether used for financial reporting, operational management, or regulatory compliance, journals in business software are indispensable tools that help organizations maintain control, transparency, and accountability across their operations.

Despite the benefits of using journals in business software, they can also often be time-consuming, resource-intensive, and/or laborious for businesses to implement. The process of meticulously recording every transaction and activity, whether financial or non-financial, involves a significant investment of time and resources. This can be particularly challenging for small businesses or organizations with limited staff, where the manual entry of data into journals may detract from other critical business functions. The need to maintain accuracy and consistency across all entries adds another layer of complexity, making the task even more demanding and prone to errors if not managed properly.

Additionally, the implementation of journals in business software often requires a thorough understanding of the specific processes and workflows within the organization. Customizing journals to capture relevant data for different departments or activities can be a complex process, involving significant planning and coordination. The integration of journals with other systems, such as inventory management or project tracking software, can also present technical challenges. These factors can make the adoption of journals a daunting task, especially for businesses without dedicated IT or accounting support, potentially leading to delays or difficulties in fully realizing the benefits of a well-organized journal system. Thus, in some embodiments, the techniques, processes, and methods described herein facilitate the use of journal entries in business software by automatically determining when a journal entry may be needed and auto populating important data and metadata into the journal entry.

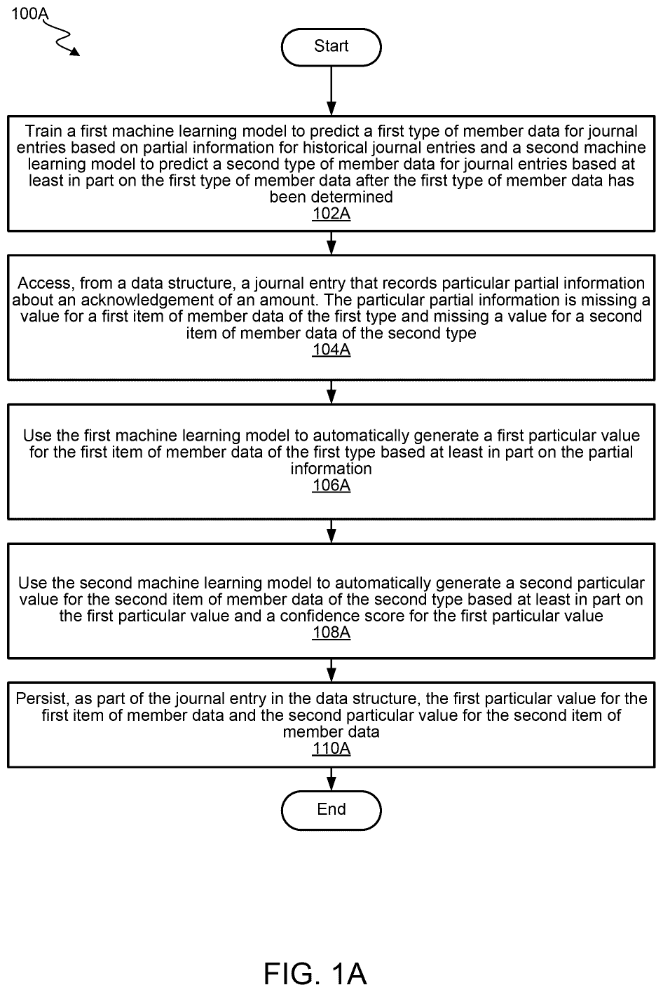

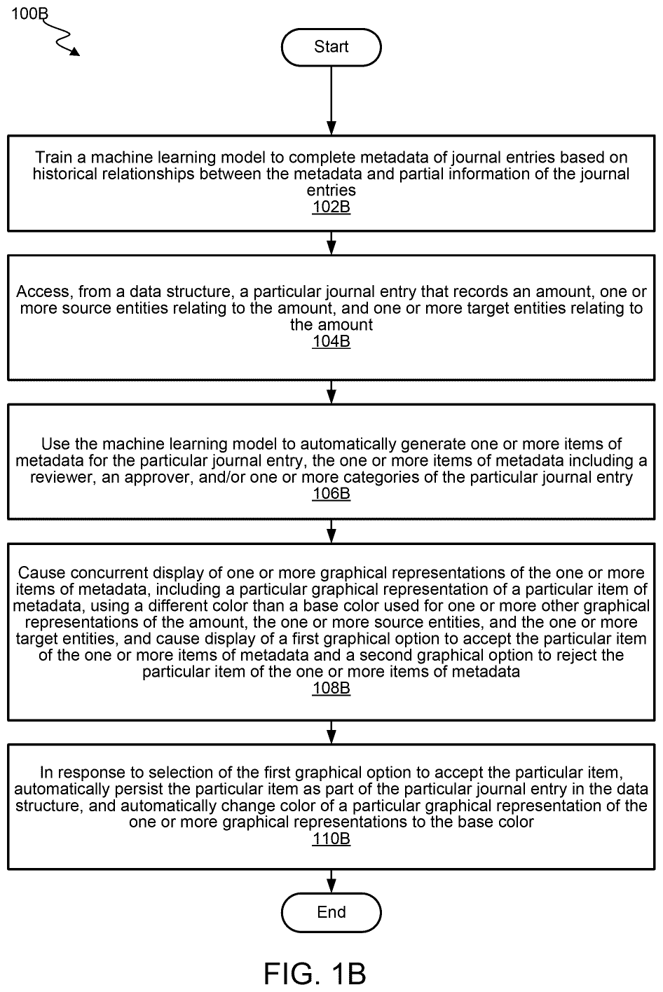

FIG. 1A illustrates a flow chart of an example sequential machine learning process 100A to determine individual values to be included for different items in a journal. As shown in block 102A, an example data management system trains a first machine learning model to predict a first type of member data for journal entries based on partial information for historical journal entries and a second machine learning model to predict a second type of member data for journal entries based at least in part on the first type of member data after the first type of member data has been determined. Example types of member data may include a metadata type (e.g., reviewer, approver, category such as intercompany, etc.), a value type (e.g., dollar amount, etc.), a description type (e.g., line description), or any other type of member data. To that end, the first type of member data may include data that is suitable for prediction using the first machine learning model that is trained on partial information. For example, assignment of new journal entries to preparers, reviewers, approvers, etc., may be predicted using the machine learning model from a limited amount of available partial information (e.g., source entity, target entity, amount, etc.). The second type of member data may include items of data that can be more accurately predicted using the second machine learning model based on actual or predicted values of one or more items of the first type. For example, the accounts to be debited and/or credited in two entities may depend on knowledge of the entities involved, reviewer/approver preferences, type of journal (e.g., or other metadata), etc. Thus, to provide a more suitable prediction for the second type of member data, some examples involve using predicted values and/or actual values of the first type of member data to predict the second type of member data.

In block 104A, the data management system accesses, from a data structure, a journal entry that records particular partial information about an acknowledgement of an amount. The particular partial information is missing a value for a first item of member data of the first type and missing a value for a second item of member data of the second type. For example, the particular partial information may be used to create a new journal entry (e.g., an amount to be acknowledged or reconciled, one or more entities involved, etc.). However, the particular partial information may be missing a few values for one or more items of a journal entry (e.g., metadata such as reviewer or approver or preparer to be assigned, line descriptions, accounts to be debited and/or credited, etc.).

In block 106A, the data management system uses the first machine learning model to automatically generate a first particular value for the first item of member data of the first type based at least in part on the partial information. For example, the data management system may use the first machine learning model to predict one or more preparers, reviewers, approvers, etc., that are likely to be accepted for working on the journal entry.

In block 108A, the data management system uses the second machine learning model to automatically generate a second particular value for the second item of member data of the second type based at least in part on the first particular value and a confidence score for the first particular value. For example, the second machine learning model can use one or more of the values predicted by the first machine learning model as inputs to predict one or more additional values in the journal entry. For instance, if the first machine learning model predicts that the category of the journal entry as an elimination or reconciliation journal entry for intercompany transactions between two entities (e.g., two companies in the same organization, etc.), then the data management system can predict which accounts need to be reconciled (e.g., payables account of a first entity against a receivables account of a second entity, etc.) and enter the corresponding account information as predicted values in the journal entry. In some instances, the data management system may account for the confidence score of the first particular value predicted by the first machine model when using it as an input for the second machine learning model. For instance, if the confidence score is relatively low, then the data management system may avoid relying on the predicted first particular value as input for the second machine learning model to save computing resources as there is a reasonable likelihood it may be rejected anyway, and so on.

In some examples, the process 100A may include the data management system determining the confidence score using the first machine learning model based at least in part on previous predicted items of data and a record of whether the previous predicted items of data were accepted, where the confidence score is indicative of a likelihood of the first particular value being accepted. For example, the first machine learning model may provide a statistical score that measures the likelihood of a predicted value being accepted, etc., based on historical journal entries. This statistical score can be used as a basis for determining the confidence score.

In some examples, the determining the confidence score may be further based on the amount associated with the acknowledgement at block 104A. For example, if the amount (e.g., discrepancy between corresponding financial accounts, etc.) is relatively high, then the data management system may reduce the confidence score. For instance, the data management system may avoid making secondary predictions based on assumptions about the first item in this scenario due to the potential impact of an error when the amount is high and/or to avoid distracting the user from confirming the first particular value with unnecessary predictions about the second item (e.g., at least until the user confirms the first particular value).

In some examples, the process 100A may include the data management system updating the confidence score based at least in part on accepting the first particular value, rejecting the first particular value, or modifying one or more items of member data in the journal entry. In an example, the data management system may then use the second machine learning model to automatically update the second particular value based on the updated confidence score. In an example, the data management system may use the second machine learning model to automatically generate a third particular value for a third item of member data of the second type based at least in part on the updated confidence score. For instance, the updated confidence score may be sufficient to accurately predict additional data items using the second machine learning model (and/or the first machine learning model) that were not possible to predict confidently when the confidence score was lower.

In block 110A, the data management system persists, as part of the journal entry in the data structure, the first particular value for the first item of member data and the second particular value for the second item of member data. For example, if the user accepts the first particular value and/or the second particular value via a user interface of the data management system, then the data management system may persist these predicted values in the data structure of the journal entry. In some examples, the data management system may also update one or more confidence scores and/or predictions based on acceptance or rejection of the first and/or second particular values, and/or based on the user updating one or more items of member data in the journal entry. For example, acceptance of a predicted value may raise its confidence score sufficiently to enable using it as a basis for predicting one or more additional items of the first type of member data (e.g., using the first machine learning model) or the second type of member data (e.g., using the second machine learning model).

In some examples, the process 100A includes the data management system causing display of a first graphical option (e.g., check mark button, etc.) to accept the first particular value for the first item of member data and a second graphical option (e.g., ‘x’ or ‘cancel’ button, etc.) to reject the first particular value for the first item of member data. In an example, the persisting the first particular value of the first item in the data structure of the journal entry at block 110A may be based on selection of the first graphical option to accept the first particular value.

Additionally or alternatively, in some examples, the process 100A includes the data management system causing display of the first graphical to accept the second particular value for the second item of member data and the second graphical option to reject the second particular value for the second item of member data. In an example, the persisting the second particular value of the second item in the data structure of the journal entry at block 110A may be based on selection of the first graphical option to accept the second particular value.

In various embodiments, the data management system may generate auto-populated journal entries based on using past user actions to train one or more machine learning models. In one embodiment, an example process may begin by training a machine learning model to complete reconciliation metadata for journal entries that reconcile discrepancies based at least in part on discrepancies having certain characteristics (e.g., labeled with corresponding past journal entries having the certain characteristics). In one example, the data management system accesses a particular journal entry that reconciles a discrepancy of a partial match between one or more first entries of a first data structure from a first source (e.g., database or data reports of a first entity, etc.) and one or more second entries of a second data structure from a second source (e.g., database or data reports of a second entity, etc.). Here, the particular journal entry may comprise particular characteristics comprising a reconciled amount field reconciling an amount of the discrepancy, a first field that identifies one or more entities associated with the one or more first entries, a partner field that identifies one or more other entities associated with the one or more first entries, and/or particular reconciliation metadata, for example. The particular reconciliation metadata may include a reviewer, an approver, one or more categories of the particular journal entry, and/or other metadata based at least in part on the particular characteristics. In this example, the data management system may use the machine learning model to automatically generate a first item of the particular reconciliation metadata and a second, different item of the particular reconciliation metadata, or any number of items of particular reconciliation data determined from the machine learning model(s) to fill in fields that are available to be filled in for the particular journal entry. The data management system may further concurrently display one or more graphical representations of the particular characteristics, a first graphical representation of the first item, a second graphical representation of the second item, a first graphical option to accept the first item, and a second graphical option to accept the second item. The first graphical representation and the second graphical representation may be presented in a different color than a base color of the one or more graphical representations of the particular characteristics. In some embodiments, in response to selection of the first graphical option to accept the first item, the graphical representation of the first item may automatically persist as part of the particular journal entry in the first data structure, and automatically change the color of the first graphical representation to the base color. Selecting the option to reject the first item may cause the particular journal entry to persist without a recommendation for the first item (e.g., as if the recommendation never existed). Feedback about the rejection and/or acceptance may be provided to the machine learning model to improve future recommendations of values for journal entry items.

In one embodiment, a ML model and/or algorithm is configured to determine if journal entries can be automatically approved, closed, and/or posted without human review. For example, the ML model may be trained on historical journal entries to determine patterns of factors associated with journal entries that were approved and patterns for journal entries that were rejected. In operation, the ML model may then predict whether a particular journal can be automatically approved and closed (posted), or whether it must be reviewed and approved by a manual process. In another embodiment, the prediction or determination may be performed within a confidence band where the highest confidence journal entries are automatically approved/closed, while lower confidence journal entries will be recommended for manual closing and posting.

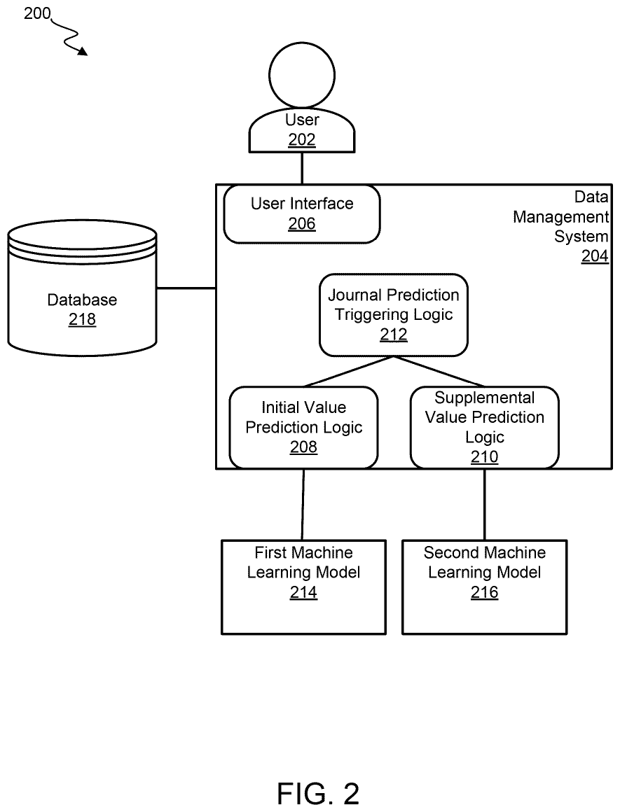

FIG. 2 depicts a sample architecture for an example system 200 to execute the methods and techniques pertaining to at least some embodiments. In the illustrated example, user 202 may interact with a User Interface 206 of Data Management System 204 to enter data or view a recommendation from Data Management System 204. Journal Prediction Triggering Logic 212 may receive information about one or more conditions that trigger value predictions for different items of a journal entry. For example, the user may open an incomplete or partially complete journal entry on User Interface 206, prompting a recommendation for how to complete the partially completed journal entry. As another example, a partially completed journal entry may be created in response to events, a schedule, or a detected discrepancy between data sets managed by different entities. Journal Prediction Triggering Logic 212 may then trigger Initial Value Prediction Logic 208 to use First Machine Learning Model 214 to predict one or more values of the journal entry. For example, Initial Value Prediction Logic may use the partially complete information from the partially complete journal entry to predict baseline information such as an amount, a source entity from which the amount is credited or debited, and a target entity to which the amount is debited or credited. Partially completed journal entry may include information about a description of a line item, any of the baseline information, or any other data describing an amount involving entities or accounts. Once the one or more values have been predicted by Initial Value Prediction Logic 208, Journal Prediction Triggering Logic 212 may further trigger Supplemental Value Prediction Logic 210 to predict (e.g., using a second machine learning model 216) one or more other values of the partially complete journal entry. For example, other values to be predicted may include a reviewer, an approver, one or more categories of the journal entry, or other metadata that is partially determined from or otherwise dependent on the one or more values predicted by Initial Value Prediction Logic 208. In one embodiment, Supplemental Value Prediction Logic 210 may utilize a large language model (LLM) such as Cohere or ChatGPT to prompt a model for a natural language description that is based on one or more other values determined from Initial Value Prediction Logic 208.

After values are predicted for the journal entry by Initial Value Prediction Logic and/or Supplemental Value Prediction Logic, the predicted values may be displayed on user interface 206 with graphical options for the user to confirm or reject the predicted values. Predicted values may be distinguished from baseline values or values that are already part of the journal entry by coloring the predicted values with a different color or otherwise graphically distinguishing the predicted values from the actual values of the partially completed journal entry. As predicted values get confirmed, the user interface may present the predicted values in a same color or graphic as the baseline values, and the confirmed values may become part of the record corresponding to the respective field for which they were predicted. Furthermore, as predicted values get confirmed or rejected and/or as the user 202 enters values for one or more items of the journal entry, the data management system 204 and/or the journal prediction triggering logic 212 may re-trigger the initial value prediction logic 208 and/or the supplemental value prediction logic 210 to obtain and/or improve predicted values by providing updated inputs to the first machine learning model 214 and/or the second machine learning model 216 according to the detected user inputs (e.g., acceptance, rejection, data entry, etc.).

### Using Artificial Intelligence and Machine Learning to Predict the Creation of Journal Entries in Business Software

In some embodiments, machine learning tools are used to automatically detect when a journal entry may be needed and/or when certain items with a pending journal entry can be predicted. To predict when a user may need to create a journal entry, past user data is curated and employed to create a model, or otherwise combined with machine learning tools to generate the predictions. This may be achieved by examining the action of the user, via interactions with the business software through button clicks and text entries. The selected algorithm may be any suitable machine learning tool that uses historical data to predict future actions. Several such tools are described below, but it will be appreciated that additional tools may be suitable.

Collaborative Filtering: This algorithm is widely used in recommendation systems and is based on the idea of making recommendations by finding similarities between users or items. There are two main types:

1). User-Based Collaborative Filtering: This approach looks for users with similar behavior or preferences and recommends items that similar users have liked or interacted with in the past.

2). Item-Based Collaborative Filtering: This approach focuses on finding similarities between items based on user interactions, recommending items that are similar to those the user has interacted with before.

Content-Based Filtering: This algorithm recommends items based on the features of the items and the user's previous interactions. It analyzes the content of items (such as keywords, categories, or descriptions) and suggests items with similar attributes to those that the user has liked or interacted with in the past.

Matrix Factorization: This is a popular technique in collaborative filtering, particularly in scenarios with large datasets, like in Netflix or Amazon recommendations. It involves breaking down a large matrix (e.g., users vs. items) into lower-dimensional matrices, capturing the latent factors or patterns in the data that can be used to predict user preferences.

Deep Learning Models: Neural networks, particularly deep learning models, can be used for more complex recommendation tasks. Three examples include:

1). Recurrent Neural Networks (RNNs): These are often used for sequence-based recommendations, where the order of user actions matters, such as in recommending the next song in a playlist.

2). Convolutional Neural Networks (CNNs): While CNNs are typically associated with image data, they can also be adapted for text and other types of structured data to find patterns and make recommendations.

3). Autoencoders: These are used to reduce dimensionality and learn efficient representations of data, which can then be used for recommendations.

Association Rule Learning: Algorithms like Apriori or Eclat are used to discover relationships between items in large datasets. These rules can then be used to recommend items that are often bought together or used together.

Reinforcement Learning: In some recommendation systems, reinforcement learning algorithms are used to continuously adapt recommendations based on user feedback. The system learns a policy that maximizes a cumulative reward by suggesting actions that are likely to lead to positive user responses.

Hybrid Models: Many modern recommendation systems combine several of the above approaches to improve accuracy and robustness. For example, a hybrid model might combine collaborative filtering with content-based filtering to leverage both user-item interactions and item features.

Each of these algorithms has unique strengths and is suited to different types of recommendation scenarios. It will be appreciated that this list serves solely as an example that additional tools are in existence or being routinely developed to achieve the same end result.

In business operations, various events can lead to the creation of journal entries in business software. And historical data or meta data associated with these events may be used by the machine learning tools. Common events that may trigger the creation of journal entry by a user include the recording of routine operational activities, such as inventory management, project updates, customer interactions, or financial transactions to name a few. For instance, when a company receives new inventory, a journal entry might be created to update stock levels and track the associated costs. Prior to the journal entry's creation by a user, the business software utilized by the company may record that the user recently checked the inventory status and that it had changed compared to the last time it was checked by that user. In this example, the machine learning software may learn to create a journal entry associated with changes in inventory. Similarly, when a project milestone is achieved, a journal entry could document the progress, resource usage, and any associated billing.

Another key event that prompts the creation of journal entries is the period-end review process. At the end of each operational cycle—be it monthly, quarterly, or annually—businesses finalize various aspects of their operations. This could include adjusting project timelines, updating employee performance metrics, or consolidating customer feedback. These operational adjustments are documented as journal entries, which then feed into broader reports that inform decision-making and strategic planning.

Interdepartmental or intercompany activities also frequently lead to the creation of journal entries, particularly in complex organizations. For example, when one department within a company transfers resources or data to another, a journal entry might be created to record the transaction and ensure that all parties involved have accurate records. Similarly, in a corporate group with multiple subsidiaries, intercompany data transfers, resource sharing, or collaborative projects are often documented through journal entries, ensuring that all entities have aligned records and can accurately report their activities.

Finally, events such as audits, compliance checks, or strategic decisions can also trigger the creation of journal entries in business software. During an audit, for instance, there might be a need to document procedural changes or compliance updates, leading to the creation of relevant journal entries. Likewise, strategic decisions-such as launching a new product line, restructuring a team, or shifting market focus-often require detailed documentation of the planning and execution phases. Journal entries serve as a tool in capturing these events, ensuring that all aspects of the business are recorded, analyzed, reconciled, and/or communicated effectively across the organization.

It will be appreciated that various embodiments, the tools and techniques described herein will use the historical user data described above during manual journal entry creation to train artificial intelligence software to create journal entries automatically to increase speed and efficiency within a business's operations. In addition to increasing efficiency, the automatic creation of journals may also serve as a proof checking or insurance against a user forgetting or neglecting to create a journal when a journal entry is necessary.

### Creation of a Specific Business Journal Entry

As described above, in some embodiments a machine learning tool may be used to predict when a journal entry may be created. However, not all journal entries are identical in business management software, and such software may offer many unique categories of journal entries. Below is a brief list of the types of journal entries available in the Oracle Cloud Enterprise Performance Management (EPM) Platform. However, it will be appreciated that additional journal entry types may be included and journal entries from other business management platforms including SAP Analytics Cloud (SAC), Workday Adaptive Planning, Anaplan, IBM Planning Analytics, OneStream, Tagetik, Vena Solutions, and Jedox.

Different types of journal entries are used to handle various financial and operational scenarios, each serving a specific purpose and triggered by distinct business events. Standard journals are commonly used for recording regular manual financial transactions, such as correcting errors or reclassifying entries. These may be triggered by day-to-day activities that require adjustments, like fixing an incorrect entry made during the initial posting. In contrast, recurring journal entries are designed to automate entries that need to be posted regularly over multiple periods, such as monthly rent payments or asset depreciation. These journal entries are set up once and automatically post in each period, making them ideal for ongoing, repetitive transactions.

Auto-reversing journal entries are used when there is a request to automatically reverse an entry in the following period, often used for temporary adjustments like accruals that need to be reversed once the actual payment is made. When transactions involve multiple currencies, multi-currency journal entries are used to ensure accurate financial reporting by handling currency conversions, such as when a company makes purchases in a foreign currency but reports in its base currency.

For tracking non-financial data alongside financial transactions, statistical journal entries are used and may be triggered by a request to record metrics like production volumes or hours worked for performance analysis. Allocations journal entries are employed when costs or revenues need to be distributed across different departments or business units, such as when allocating IT expenses based on usage. Intercompany journal entries are essential for recording transactions between different entities within the same corporate group, ensuring that both sides of the transaction are accurately reflected in the financial records, especially during intercompany sales or transfers.

Finally, top-side journal entries may be used at the consolidation level, often triggered by consolidation processes or management decisions that involve adjustments at the group level, such as intercompany eliminations or tax provisions. These various journal types in Oracle EPM are vital for maintaining accurate financial records and providing comprehensive insights into different aspects of the business.

In some embodiments, the specific triggers that initiate a specific journal entry's creation by a user will also be associated with the specific type selected for creation by the machine learning tools. This feature reduces the time a user requires to create a journal entry de novo and the user specify the journal entry class to create.

In some embodiments the automated journal entry creation will be temporary, and the user will have the option to close the journal entry and delete any record of the journal entry. Thus, if the machine learning tools predict that a journal entry should be created, but the data management system receives input from the user rejecting the journal entry (and/or one or more items predicted therein) as proposed, the data management system may delete any record of the journal entry (and/or one or more of the predicted items in the journal entry). Additionally, journal entries generated automatically as a result of the machine learning tools may have the same editable fields as standard journal entries created by the user. For both types of journal entries, the data management system supports editing fields for which a user has permission before saving and closing the journal entry.

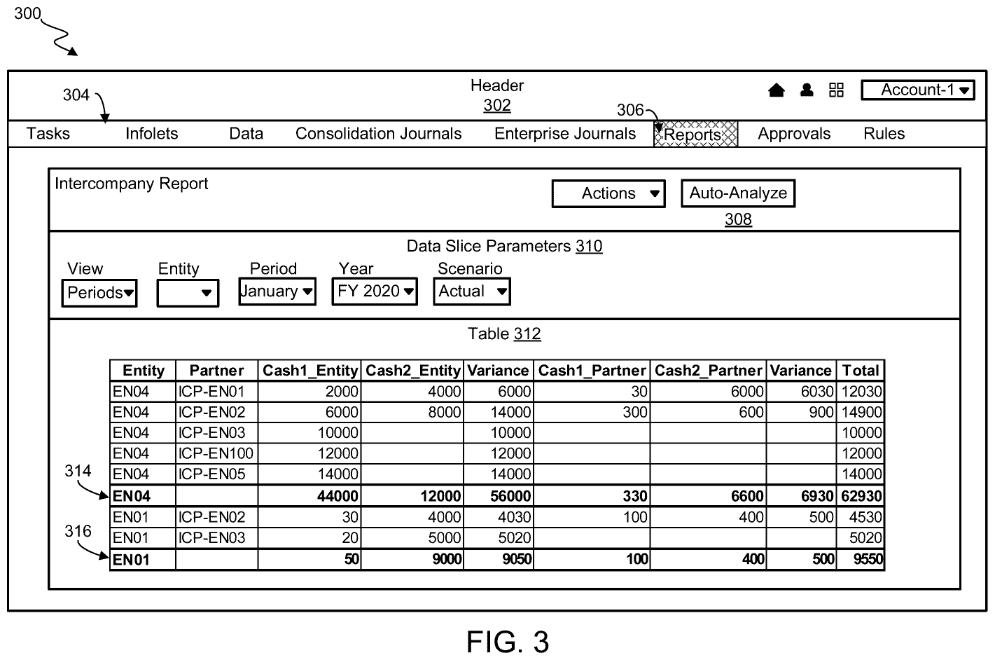

FIG. 3 shows an example user interface 300 displaying an example intercompany report that might serve as the basis for a financial reconciliation where mismatches (e.g., discrepancies) in accounts payable and accounts receivable are identified between two entities. The user interface 300 includes a header 302 which includes one or more user interface (UI) elements, a navigation bar 304 that includes a selected navigation page 306, a selectable input element 308, data slice parameters 310, and table 312. The header 302 includes information and/or UI elements associated with an application or user account of a user of the UI 300. The navigation bar 304 includes selectable links to navigate to various modules or application features. For example, selected navigation item 306 indicates that the user is currently using the ‘Reports’ feature. The input element 308 is a selectable option (e.g., first option at block 112 of process 100A) that a user can select (e.g., click a button) to instruct the data management system to automatically generate one or more journal entries or other reconciliation entries for one or more discrepancies in the report using the machine learning model (i.e., without necessarily identifying an individual discrepancy). The data slice parameters 310 indicates one or more parameters for selecting a data slice (e.g., view, period, year, scenario, etc.) for which the data in the table 312 is compiled in the report.

The first column of the table 312 (e.g., labeled ‘Entity’) identifies EN04 as the principal entity being examined. The second column of the table 312 (e.g., labeled ‘Partner’) identifies the trading partner of the entity. In the top row example, the partner is ICP_EN01 (Inter Company Partner Entity 01). In this example, the third and fourth columns (e.g., labeled ‘Cash1_Entity’ and ‘Cash2_entity’) each represent assets claimed by the first entity, EN04. The total claims or variance depicted in column 5 (e.g., labeled ‘Variance’) for the first entity are thus ‘6000’.

Continuing with the example of the top row, the partner entity (ICP_EN01) reports two assets against EN04. These are depicted as ‘30’ and ‘6000’ in columns 6 and 7 for a total variance of ‘6030’. Thus, between the two entities, EN04 and ICP_EN01, there is a total mismatch, or variance, of ‘12030’ because the amounts are not offsetting.

The rows 314 and 316 represent totals of the various columns associated with a specific entity against all partners or entities. For example, row 314 shows the entity ‘EN04’ claims a total ‘Cash1_entity’ assets of 44000 against all the partners (e.g., ICP-EN01, ICP-EN02, ICP-EN03, ICP-EN100, and ICP-EN05), and so on. Similarly, row 316 shows the sums for entity ‘EN01’.

In an intercompany report, when there is a mismatch between accounts receivable and accounts payable, accounts payable may be the source of the discrepancy for several reasons. One reason is the timing difference in recording transactions. When one entity sends an invoice, the entity promptly records it as an account receivable. However, the receiving entity might delay recording the invoice as an account payable due to internal processing times, approval procedures, or administrative delays. This timing difference can cause a temporary mismatch between the two accounts.

Another reason is the possibility of incomplete or missing entries on the accounts payable side. If an invoice is lost, overlooked, or not processed correctly, the invoice may never be recorded as a payable, even though the corresponding receivable has already been recorded by the other entity. This leads to a situation where accounts receivable reflect an amount that is not mirrored or offset in accounts payable, creating a mismatch.

Discrepancies in valuation or currency conversion also contribute to mismatches. In cases where intercompany transactions involve different currencies or complex valuation methods, the accounts payable side might not match the accounts receivable due to errors in currency conversion, incorrect application of exchange rates, or differences in how the transaction's value was calculated. If the conversion or valuation is not done accurately, the accounts payable might understate or overstate the amount owed.

Additionally, different accounting practices or systems used by entities within a corporate group can lead to inconsistencies in how transactions are recorded. For example, if one entity records a transaction on a cash basis while another uses accrual accounting, a mismatch can occur. Accounts payable is often more susceptible to such discrepancies due to the varying ways different entities handle their obligations. Overall, while both accounts receivable and accounts payable can be sources of mismatches, the accounts payable side tends to be more prone to delays, errors, and discrepancies in recording, making it a common source of mismatches in intercompany reports.

In some embodiments, stored heuristics, triggers, and/or a first machine learning model has access to financial ledgers and intercompany reports to automatically identify such mismatches in financial reporting. Several different classes of machine learning and artificial intelligence algorithms may be employed to identify such mismatches. One such class of algorithms include Anomaly Detection Algorithms, such as Isolation Forest, One Class Support Vector Machine models, or Autoencoders. These algorithms are designed to identify unusual patterns of outliers in data, which could indicate discrepancies in financial reports.

Data Reconciliation Tools represent another class of algorithms that may used in some embodiments to identify mismatches. Such tools are specialized to identify and designed to reconcile discrepancies between datasets. Examples of Data Reconciliation Tools include Fuzzy Matching Algorithms and Rule-Based Matching.

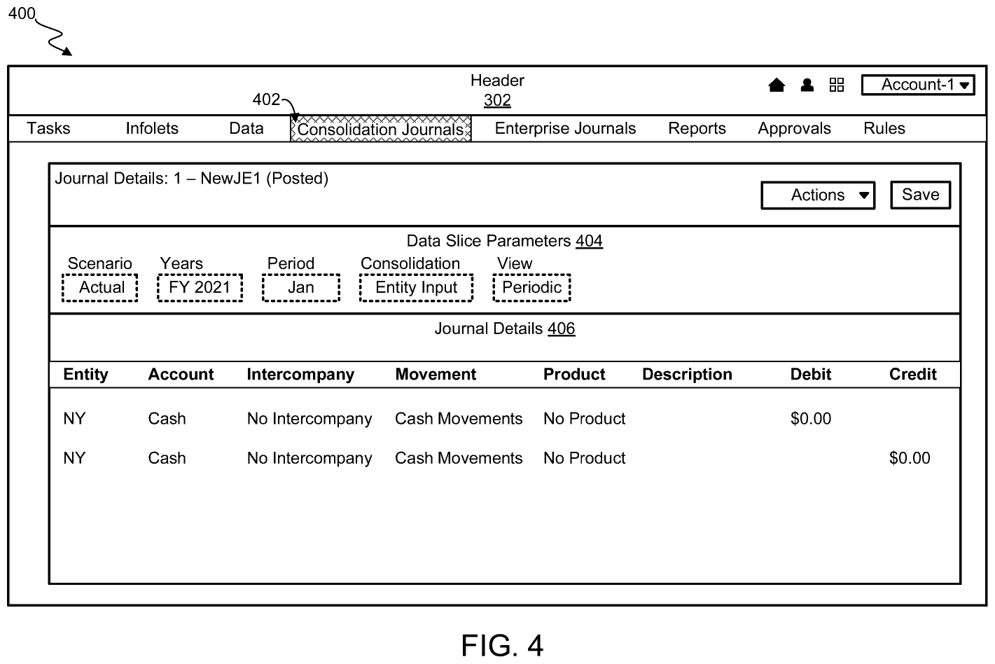

Additional examples of potential tools for identifying mismatches in financial reporting may include Regression Analysis, Clustering Algorithms, Machine Learning Classification Models, and various Data Visualization Tools. FIG. 4 shows an example user interface 400 displaying an example suggested journal entry that may be automatically created by the data management system for resolving a mismatch between two entities. For example, the journal entry may be created and balances the credit between the entities such that the variance is equal to zero. In the illustrated example, the UE 400 shows that the selected navigation item or module 402 is ‘Consolidation Journals’. The data slice parameters 404 show the selected data slice parameters corresponding to the data in this journal entry. The journal details 406 shows the details of the journal entry.

In some embodiments, should the user choose to accept the journal entry created by a machine learning model, the journal entry may be saved automatically against a ledger of both entities involved, and/or the data management system may present a selectable option to save the journal entry. FIG. 4 shows the save button depicted in the top right corner of the journal module of the user interface 400 for the data management system. Prior to saving the journal entry, the data management system provides an interface for users to make adjustments to any editable field in the journal entry and then a selectable option to save adjustments made.

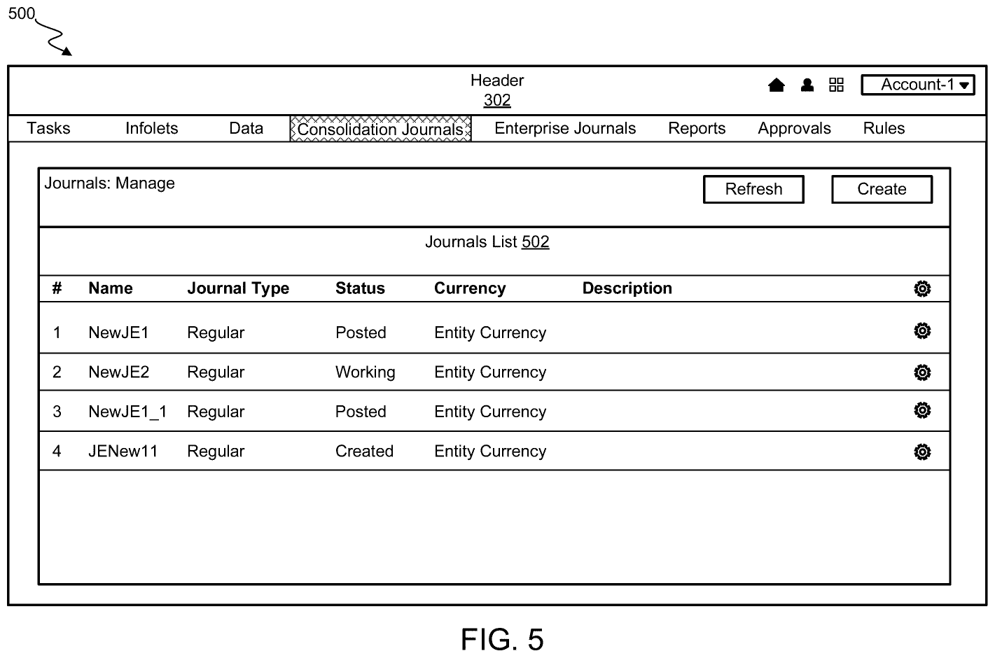

FIG. 5 shows an example user interface 500 showing an overview of a journals module from the data management system and a newly created journal entry listed as ‘Created’ (bottom row of journals list 502). The journal entry is present and listed as Working in response to automatic creation and saving of the journal entry and/or based on user input saving the journal entry. In the event that user input is received to decline to save the journal entry, the journal entry may be automatically deleted and removed from the record as if the journal entry (previously shown as created) never existed. For example, the fourth row shows an example new journal entry (Name: ‘JENew11’) that was created by the data management system (e.g., automatically generated with one or more values predicted using one or more machine learning models) but not yet saved or accepted (Status: ‘Created’). In the illustrated example, a status of ‘Working’ may signify that a journal entry has been created and saved, but that the journal entry has not necessarily completed the workflow procedure (e.g., Status: ‘Posted’).

### Using Artificial Intelligence and Machine Learning to Auto Populate Data and Metadata Fields in Business Software

Business journal entries may contain different types of information including data such as raw data and metadata. Data refers to facts, figures, or information that can be processed or analyzed to derive meaning. Raw data exists as an observed condition of an existing data set whether the journal entry separately exists or not. The data can include numerical values, text, images, or any other type of information collected from various sources. Raw data on its own may lack context and may not provide a complete understanding until the raw data is processed or analyzed. Metadata is data describing other raw data or other metadata. Metadata provides additional context or information that helps describe, categorize, and manage the primary data. Metadata includes details such as the data's origin, format, structure, and how the data should be used or interpreted. For example, metadata for a digital photograph might include information about the camera settings, date and time the photo was taken, and the location where it was captured. The distinction between raw data and metadata lies in their roles: raw data represents the actual content or facts, while metadata provides context and meaning to that content, enabling better management, understanding, and utilization of the raw data.

Metadata associated with a journal entry may include various elements that provide context and management information for each entry. The metadata may include journal entry header information, such as a unique name or description, identification number, type, relevant period or date, reviewer, approver, and/or the current status of the journal entry. This information helps in categorizing and identifying the journal entry accurately.

Line item details may also be included in the metadata and include account numbers, debit and credit amounts, business segments, and any relevant intercompany information that provides deeper detail to the raw data being reported by the journal entry. These details are useful for accurate financial tracking and reporting. Additionally, supporting details and attachments such as invoices, receipts, or explanatory comments provide further context and documentation for the journal entries.

Approval and workflow information tracks the review process, including who approved the journal and any comments made during the approval stages. Finally, reconciliation information links the journal to specific reconciliation processes, promoting consistency and accuracy with related entries. This metadata collectively ensures that journal entries are well-documented, traceable, and effectively integrated into the broader financial management and reporting system.

In some embodiments, the journal entries created using the machine learning algorithms and tools will be auto populated using the appropriate metadata for that journal type. The machine learning tools may be trained on historical data examining how those same metadata fields were populated by a human user in the past. For instance, a user may tend to enter in their own name as the person responsible for the creation of their journal entry and, in this case, the machine learning tools may propagate this decision to the auto-generated journal entries so they may be efficiently located by the user. The same may be true for entering in the name of supervisors for approvals and any other metadata entry.

As described above, it will be appreciated that the auto-generated metadata in the auto-generated journal entries may also be editable by the user given that they have permission to do so. In some embodiments, the data management system provides editable fields for the metadata that are modifiable by user input. If the field values of automatically generated raw data or metadata are changed, the changes may be fed into the machine learning model to train or tune the model to make better predictions for the values in the future. For example, value decisions by the model that are inconsistent with the change may be weighted lower than value decisions by the model that are consistent with the change when a similar scenario arises.

In some examples, primary data associated with a business journal may include core information that captures the details of financial and operational transactions. This may include account details, such as the specific ledger accounts or separate sets of financial data being debited or credited, and the corresponding amounts for each entry. Transaction dates may also be included in core information for a journal entry, marking when the financial activity occurred and when it is recorded in the journal entry. Additionally, descriptive information provides context for the entries, such as the nature of the transaction or the reason for the adjustment. For intercompany transactions, counterparty details may be included to identify the involved entities within the organization. Reference numbers or invoice IDs might be attached to link the journal entries to supporting documentation or external records. This primary data ensures that each journal entry is accurately recorded, providing a clear and detailed account of financial activities for reporting and analysis purposes.

As with metadata, in some embodiments the machine learning tools will create journal entries specific to a trigger and auto populate the data fields with relevant data. For instance, entering a new transaction into a business ledger within the business software may auto populate data fields pertaining to the financial amount of the transaction, the date of the transaction, and appropriate accounts receivable and payable. As described above, the new journal entry and its corresponding data items may be disregarded, saved, or edited where permissions are granted.

It will be appreciated that the machine learning model to automatically generate raw data, core data, and metadata items into the journal entries may be part of the same model that determines when and what type of journal entry to create. Alternatively, the machine learning model to generate data may be a separately trained and optimized model that is integrated into the business enterprise software.

### Tracking Separately Reviewed Items of Member Data of a Journal Entry

In one embodiment, items of metadata are graphically marked for review to distinguish reviewed items from items yet to be reviewed. FIG. 1B illustrates a flow chart of another example guided machine learning process 100B to determine individual values to be included for different items in a journal. In block 102B, an example data management system trains a machine learning model to complete metadata of journal entries based on historical relationships between the metadata and partial information of the journal entries. In block 104B, the data management system accesses, from a data structure (e.g., Table 3, database 218, etc.), a particular journal entry that records an amount, one or more source entities relating to the amount, and one or more target entities relating to the amount. In block 106B, the data management system uses the machine learning model to automatically generate one or more items of metadata for the particular journal entry, the one or more items of metadata including a reviewer, an approver, and/or one or more categories of the particular journal entry. In block 108B, the data management system causes concurrently display of one or more graphical representations of the one or more items of metadata, including a particular graphical representation of a particular item of metadata, using a different color than a base color used for one or more other graphical representations of the amount, the one or more source entities, and the one or more target entities. The data management system also causes display of a first graphical option to accept the particular item of the one or more items of metadata and a second graphical option to reject the particular item of the one or more items of metadata. In block 110B, in response to the selection of the first graphical option to accept the particular item, the data management system automatically persists the particular item as part of the particular journal entry in the data structure, and automatically changes color of a particular graphical representation of the one or more graphical representations to the base color.

In a particular example, raw data items or data items that were not automatically predicted may appear in a black or dark color, and predicted items may appear in a red, orange, or blue color to indicate that the items require attention. An option to accept and/or an option to reject each of the items requiring attention may be displayed. In one embodiment, the options to accept or reject a given item are displayed as a pop-up menu when the item is selected. In another embodiment, the options are displayed as checkboxes, buttons, or other selectable graphical elements adjacent to the items requiring attention.

Upon selection of the option to accept a given item, the item may be recolored to match the raw data items that were not automatically predicted, such as in a black or dark color. The item may then be saved as part of the journal entry and become part of the raw data of the journal entry. Upon selection of the option to reject a given item, the item may be cleared or a previous value for the item that was recommended to be replaced by a prediction may re-appear. After clearing the recommendation for the given item, the recommendation may be deleted from the data management system as if it never existed. Alternatively, an indication may be stored that the recommendation was made and rejected to avoid having the same recommendation re-made in the future for the same journal entry.

In some examples, the machine learning model at 102B is a first machine learning model, and the process 100B includes the data management system training a second machine learning model to predict member data for journal entries based at least in part on items of metadata. In an example, the data management system then uses the second machine learning model to automatically generate one or more values for one or more items of member data for the particular journal entry based at least in part on the particular item of metadata predicted using the first machine learning model and a confidence score for the particular item of metadata.

### Example of Automated Journal Entry

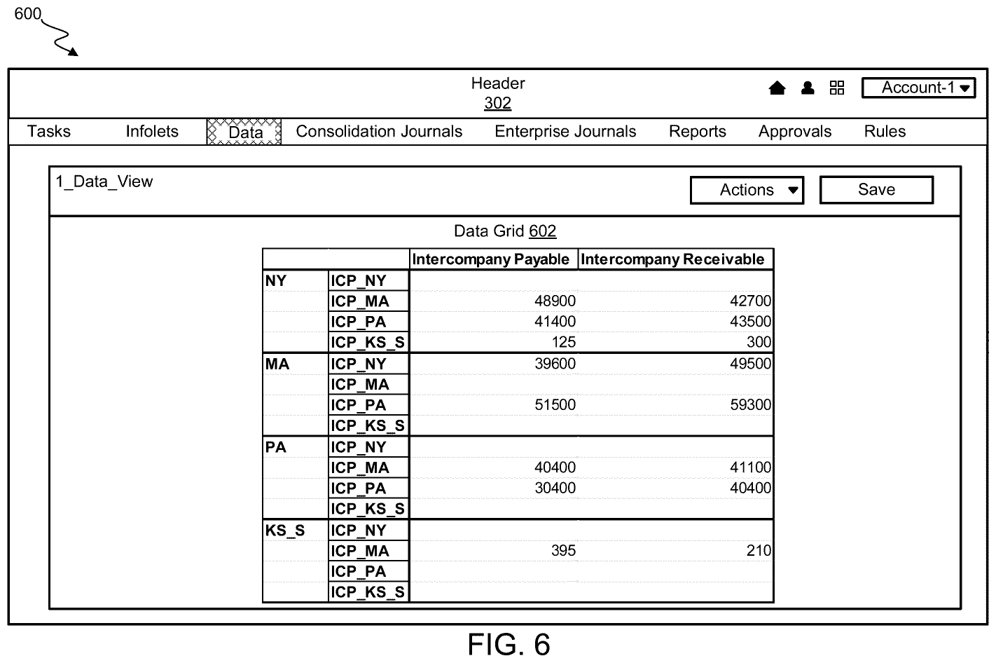

FIG. 6 illustrates an example user interface 600 that shows an example of a data entry that may trigger a journal to be automatically generated. The example will further show how data and metadata may be incorporated into a specific journal class that resolved financial mismatches between two financial entities.

Specifically, FIG. 6 shows an example of how data may be stored to generate an intercompany matching report. In this example, there is a mismatch between the financial reports of the two financial fictional entities NY and MA. FIG. 6 includes a data grid 602 which shows the data that comes from the ledger and may represent the source of the mismatch that is highlighted in an intercompany mismatch report. This data may be entered in manually and algorithms (including simple comparators, artificial intelligence tools, or machine learning tools) may be employed to screen such documents for mismatches. Here for instance, the second row for the entity NY shows the intercompany partner to be ICP_MA. The Account Payable for the entity NY with regards to ICP_MA is 48900. This represents the finances owed by NY to ICP_MA. FIG. 6 further shows that when MA is the primary entity and the partner is ICP_NY, the accounts receivable is 49500. This now implies that the entity ICP_NY owes MA 49500. Thus, there is a mismatch and discrepancy between the two entities with regards to how much is owed by the entity NY to the entity MA. In some examples, the data grid 602 is configured to receive input from the user of the user interface 600 (e.g., to adjust one or more of the values in the data grid 602). Once this discrepancy is detected using software a journal entry is automatically created and presented to the user to keep, edit, or discard.

In the example above, the specific journal entry class (e.g., category) that is created will pertain to reconciling financial reports between financial entities. This journal entry class will be selected because it is the most likely journal entry class that a past user would initiate given a mismatch in financial statements between entities. As the machine learning tools are trained using past user data, the financial reconciliation journal entry becomes the most likely output of the machine learning tool as well.

In addition to creating a journal entry of the class specific to the triggering event, in some embodiments data and metadata fields will also be auto populated. In this event, the most likely source of error is from accounts payable. Past user actions would capture this correlation and this correlation would thus be captured in the output recommendations of any suitable machine learning tools.

Accounts payable is often the source of discrepancies in intercompany financial reconciliation reports due to the complexity of managing and reconciling transactions between multiple entities within a corporate group. These discrepancies typically arise from timing differences, such as when invoices are recorded or payments are made at different times by the involved entities. Additionally, inconsistencies can occur due to variations in recording practices, errors in data entry, or mismatches in the amounts recorded by each party. Since accounts payable involves numerous transactions and relies on accurate cross-entity communication and documentation, any errors or delays in these processes can lead to significant discrepancies that impact the reconciliation of intercompany accounts.

In some embodiments, the autogenerated journal entry would adjust the data (numbers) of the accounts payable to match the data of accounts receivable, as this is the most parsimonious solution to resolving the discrepancy and most consistent with past user actions.

In addition to auto populating data, meta data may also be auto populated in the machine learning generated journal entry. The meta data may include when the journal entry was created, the owner of the journal entry, the supervisor responsible for accepting the journal entry, and potentially the names of the entities described in the journal entry.

As mentioned previously, in some embodiments, various fields of the data and metadata may be edited by the user if they have permission, the journal entry may be deleted by closing a recommended journal entry before saving the recommended journal entry. Alternatively, the journal entry may be saved by clicking a save button or automatically saved by the system.

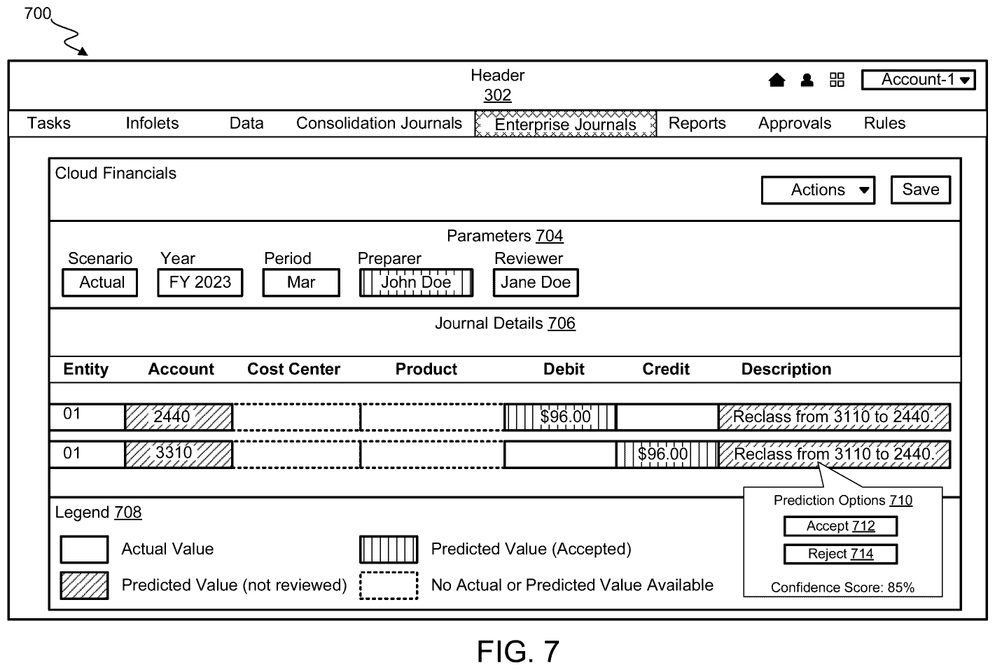

FIG. 7 illustrates an example user interface 700 that shows a sample journal entry generated using an example data management system, and that could be generated by a user or automatically using the tools and techniques described herein. The figure shows editable data fields and/or metadata fields that may be further edited by the user. It will be appreciated that the techniques described herein may be applied to other financial management platforms and are not restricted to the Oracle EPM platform.

In the illustrated example, the UI 700 includes one or more parameters 704, which may include data slice parameters (e.g., scenario, year, period) as well as other metadata (e.g., preparer, reviewer, etc.) associated with the journal entry. The UI 700 also includes journal details 706 showing details (e.g., transactions) in the journal entry, a legend 708 showing graphical representations used to visually indicate which various items of data are predicted values, actual values, accepted predicted values, and/or items where no actual or predicted value is available. It is noted that patterned backgrounds are used to indicate the various graphical representations of the various items of data for convenience in description. However, in some embodiments, the status of various fields in the journal entry can be alternatively indicated using colors or other graphical characteristics. In the illustrated example, the UI 700 also includes a pop-up menu, labeled as Prediction options 710. For example, the prediction options 710 may be displayed (e.g., overlayed) adjacent or near an item of data that is selected (e.g., mouse-over, click, etc.) by the user of the UI 700. In this example, the prediction options 710 are displayed for the data field corresponding to the description of the second row of data in the journal details 706. For instance, the user can select the accept 712 option to accept the predicted value associated with this field (e.g., ‘Reclass from 3110 to 2440.’) or select the reject 714 option to reject the predicted value. If accepted, the UI may update the graphical representation of the text field (e.g., to the vertical lines pattern) to indicated that this was a predicted value that was accepted. If the user rejects the predicted value, the UI 700 may remove the data inside the field and/or change its graphic appearance accordingly (e.g., to indicate that there is no actual or predicted value available for this field).

In the illustrated example, the options 710 menu may also include an indication of the confidence score (e.g., ‘confidence score: 85%’) associated with the currently selected predicted value. This information may assist the user of UI 700, for example, with making an informed decision to either accept or reject the predicted value.

### Computer System Architecture

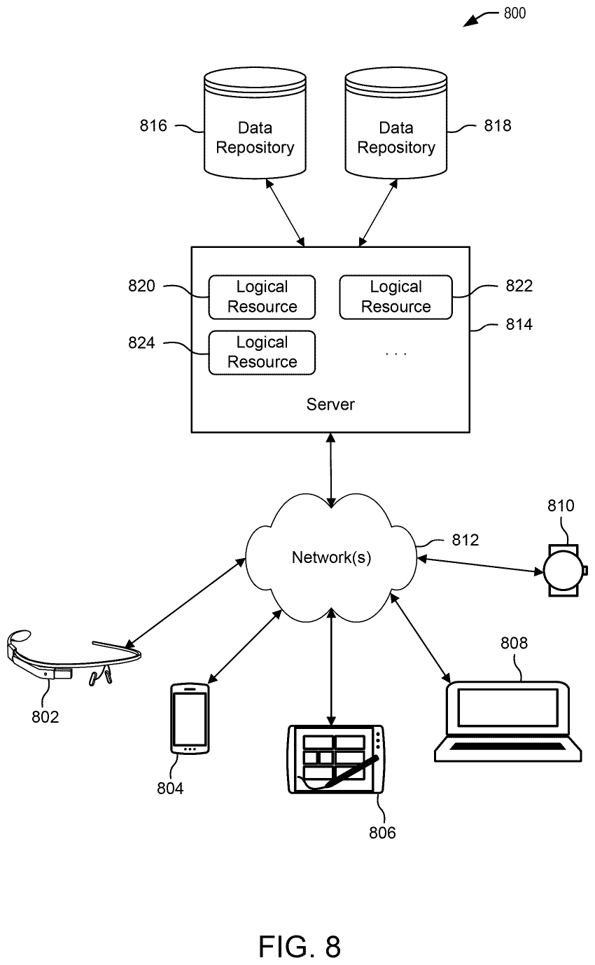

FIG. 8 depicts a simplified diagram of a distributed system 800 for implementing an embodiment. In the illustrated embodiment, distributed system 800 includes one or more client computing devices 802, 804, 806, 808, and/or 810 coupled to a server 814 via one or more communication networks 812. Clients computing devices 802, 804, 806, 808, and/or 810 may be configured to execute one or more applications.

In various aspects, server 814 may be adapted to run one or more services or software applications that enable techniques for using a guided machine learning process to determine individual values to be included for different items in a journal.

In certain aspects, server 814 may also provide other services or software applications that can include non-virtual and virtual environments. In some aspects, these services may be offered as web-based or cloud services, such as under a Software as a Service (SaaS) model to the users of client computing devices 802, 804, 806, 808, and/or 810. Users operating client computing devices 802, 804, 806, 808, and/or 810 may in turn utilize one or more client applications to interact with server 814 to utilize the services provided by these components.

In the configuration depicted in FIG. 8, server 814 may include one or more components 820, 822 and 824 that implement the functions performed by server 814. These components may include software components that may be executed by one or more processors, hardware components, or combinations thereof. It should be appreciated that various different system configurations are possible, which may be different from distributed system 800. The embodiment shown in FIG. 8 is thus one example of a distributed system for implementing an embodiment system and is not intended to be limiting.

Users may use client computing devices 802, 804, 806, 808, and/or 810 for techniques for using a guided machine learning process to determine individual values to be included for different items in a journal in accordance with the teachings of this disclosure. A client device may provide an interface that enables a user of the client device to interact with the client device. The client device may also output information to the user via this interface. Although FIG. 8 depicts only five client computing devices, any number of client computing devices may be supported.

The client devices may include various types of computing systems such as smart phones or other portable handheld devices, general purpose computers such as personal computers and laptops, workstation computers, personal assistant devices, smart watches, smart glasses, or other wearable devices, equipment firmware, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux® or Linux-like operating systems such as Oracle® Linux and Google Chrome® OS) including various mobile operating systems (e.g., Microsoft Windows Mobile®, iOS®, Windows Phone®, Android™, HarmonyOS®, Tizen®, KaiOS®, Sailfish® OS, Ubuntu® Touch, CalyxOSX®). Portable handheld devices may include cellular phones, smartphones, (e.g., an iPhone®), tablets (e.g., iPad®), and the like. Virtual personal assistants such as Amazon® Alexa®, Google® Assistant, Microsoft® Cortana®, Apple® Siri®, and others may be implemented on devices with a microphone and/or camera to receive user or environmental inputs, as well as a speaker and/or display to respond to the inputs. Wearable devices may include Apple® Watch, Samsung Galaxy® Watch, Meta Quest®, Ray-Ban® Meta® smart glasses, Snap® Spectacles, and other devices. Gaming systems may include various handheld gaming devices, Internet-enabled gaming devices (e.g., a Microsoft Xbox® gaming console with or without a Kinect® gesture input device, Sony PlayStation® system, Nintendo Switch®, and other devices), and the like. The client devices may be capable of executing various different applications such as various Internet-related apps, communication applications (e.g., e-mail applications, short message service (SMS) applications) and may use various communication protocols.

Network(s) 812 may be any type of network familiar to those skilled in the art that can support data communications using any of a variety of available protocols, including without limitation TCP/IP (transmission control protocol/Internet protocol), SNA (systems network architecture), IPX (Internet packet exchange), AppleTalk, and the like. Merely by way of example, network(s) 812 can be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth, and/or any other wireless protocol), and/or any combination of these and/or other networks.

Server 814 may be composed of one or more general purpose computers, specialized server computers (including, by way of example, PC (personal computer) servers, UNIX® servers, LINUX® servers, mid-range servers, mainframe computers, rack-mounted servers, etc.), server farms, server clusters, a Real Application Cluster (RAC), database servers, or any other appropriate arrangement and/or combination. Server 814 can include one or more virtual machines running virtual operating systems, or other computing architectures involving virtualization such as one or more flexible pools of logical storage devices that can be virtualized to maintain virtual storage devices for the server. In various aspects, server 814 may be adapted to run one or more services or software applications that provide the functionality described in the foregoing disclosure.

The computing systems in server 814 may run one or more operating systems including any of those discussed above, as well as any commercially available server operating system. Server 814 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, SAP®, Amazon®, Sybase®, IBM® (International Business Machines), and the like.

In some implementations, server 814 may include one or more applications to analyze and consolidate data feeds and/or event updates received from users of client computing devices 802, 804, 806, 808, and/or 810. As an example, data feeds and/or event updates may include, but are not limited to, blog feeds, Threads® feeds, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 814 may also include one or more applications to display the data feeds and/or real-time events via one or more display devices of client computing devices 802, 804, 806, 808, and/or 810.

Distributed system 800 may also include one or more data repositories 816, 818. These data repositories may be used to store data and other information in certain aspects. For example, one or more of the data repositories 816, 818 may be used to store information for techniques for using a guided machine learning process to determine individual values to be included for different items in a journal. Data repositories 816, 818 may reside in a variety of locations. For example, a data repository used by server 814 may be local to server 814 or may be remote from server 814 and in communication with server 814 via a network-based or dedicated connection. Data repositories 816, 818 may be of different types. In certain aspects, a data repository used by server 814 may be a database, for example, a relational database, a container database, an Exadata® storage device, or other data storage and retrieval tool such as databases provided by Oracle Corporation® and other vendors. One or more of these databases may be adapted to enable storage, update, and retrieval of data to and from the database in response to structured query language (SQL)-formatted commands.

In certain aspects, one or more of data repositories 816, 818 may also be used by applications to store application data. The data repositories used by applications may be of different types such as, for example, a key-value store repository, an object store repository, or a general storage repository supported by a file system.

In one embodiment, server 814 is part of a cloud-based system environment in which various services may be offered as cloud services, for a single tenant or for multiple tenants where data, requests, and other information specific to the tenant are kept private from each tenant. In the cloud-based system environment, multiple servers may communicate with each other to perform the work requested by client devices from the same or multiple tenants. The servers communicate on a cloud-side network that is not accessible to the client devices in order to perform the requested services and keep tenant data confidential from other tenants.

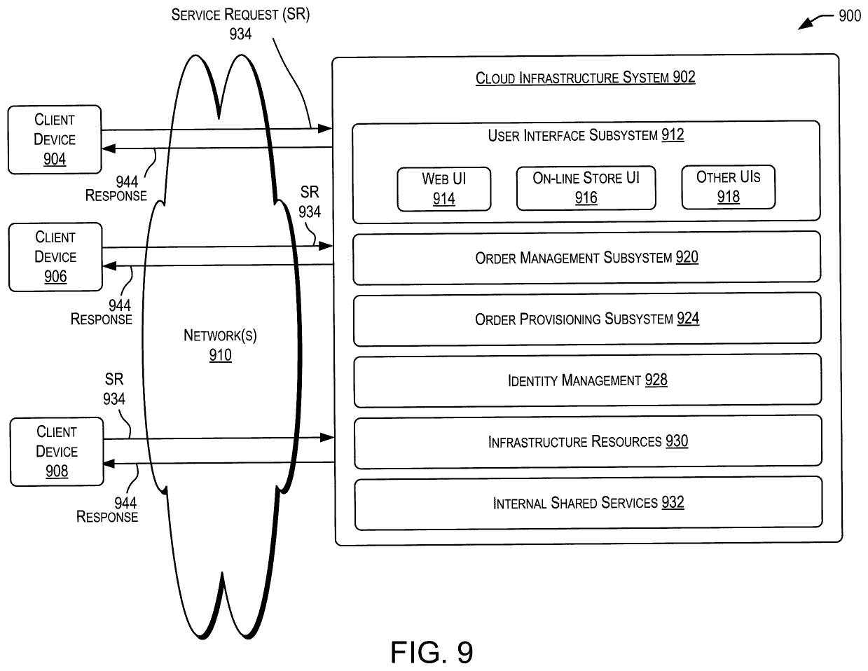

FIG. 9 is a simplified block diagram of a cloud-based system environment in which using a guided machine learning process to determine individual values to be included for different items in a journal, in accordance with certain aspects. In the embodiment depicted in FIG. 9, cloud infrastructure system 902 may provide one or more cloud services that may be requested by users using one or more client computing devices 904, 906, and 908. Cloud infrastructure system 902 may comprise one or more computers and/or servers that may include those described above for server 814. The computers in cloud infrastructure system 902 may be organized as general purpose computers, specialized server computers, server farms, server clusters, or any other appropriate arrangement and/or combination.

Network(s) 910 may facilitate communication and exchange of data between clients 904, 906, and 908 and cloud infrastructure system 902. Network(s) 910 may include one or more networks. The networks may be of the same or different types. Network(s) 910 may support one or more communication protocols, including wired and/or wireless protocols, for facilitating the communications.

The embodiment depicted in FIG. 9 is only one example of a cloud infrastructure system and is not intended to be limiting. It should be appreciated that, in some other aspects, cloud infrastructure system 902 may have more or fewer components than those depicted in FIG. 9, may combine two or more components, or may have a different configuration or arrangement of components. For example, although FIG. 9 depicts three client computing devices, any number of client computing devices may be supported in alternative aspects.

The term cloud service is generally used to refer to a service that is made available to users on demand and via a communication network such as the Internet by systems (e.g., cloud infrastructure system 902) of a service provider. Typically, in a public cloud environment, servers and systems that make up the cloud service provider's system are different from the cloud customer's (“tenant's”) own on-premise servers and systems. The cloud service provider's systems are managed by the cloud service provider. Tenants can thus avail themselves of cloud services provided by a cloud service provider without having to purchase separate licenses, support, or hardware and software resources for the services. For example, a cloud service provider's system may host an application, and a user may, via a network 910 (e.g., the Internet), on demand, order and use the application without the user having to buy infrastructure resources for executing the application. Cloud services are designed to provide easy, scalable access to applications, resources, and services. Several providers offer cloud services. For example, several cloud services are offered by Oracle Corporation®, such as database services, middleware services, application services, and others.

In certain aspects, cloud infrastructure system 902 may provide one or more cloud services using different models such as under a Software as a Service (SaaS) model, a Platform as a Service (PaaS) model, an Infrastructure as a Service (IaaS) model, a Data as a Service (DaaS) model, and others, including hybrid service models. Cloud infrastructure system 902 may include a suite of databases, middleware, applications, and/or other resources that enable provision of the various cloud services.

A SaaS model enables an application or software to be delivered to a tenant's client device over a communication network like the Internet, as a service, without the tenant having to buy the hardware or software for the underlying application. For example, a SaaS model may be used to provide tenants access to on-demand applications that are hosted by cloud infrastructure system 902. Examples of SaaS services provided by Oracle Corporation® include, without limitation, various services for human resources/capital management, client relationship management (CRM), enterprise resource planning (ERP), supply chain management (SCM), enterprise performance management (EPM), analytics services, social applications, and others.

An IaaS model is generally used to provide infrastructure resources (e.g., servers, storage, hardware, and networking resources) to a tenant as a cloud service to provide elastic compute and storage capabilities. Various IaaS services are provided by Oracle Corporation®.

A PaaS model is generally used to provide, as a service, platform and environment resources that enable tenants to develop, run, and manage applications and services without the tenant having to procure, build, or maintain such resources. Examples of PaaS services provided by Oracle Corporation® include, without limitation, Oracle Database Cloud Service (DBCS), Oracle Java Cloud Service (JCS), data management cloud service, various application development solutions services, and others.

A DaaS model is generally used to provide data as a service. Datasets may searched, combined, summarized, and downloaded or placed into use between applications. For example, user profile data may be updated by one application and provided to another application. As another example, summaries of user profile information generated based on a dataset may be used to enrich another dataset.

Cloud services are generally provided on an on-demand self-service basis, subscription-based, elastically scalable, reliable, highly available, and secure manner. For example, a tenant, via a subscription order, may order one or more services provided by cloud infrastructure system 902. Cloud infrastructure system 902 then performs processing to provide the services requested in the tenant's subscription order. Cloud infrastructure system 902 may be configured to provide one or even multiple cloud services.

Cloud infrastructure system 902 may provide the cloud services via different deployment models. In a public cloud model, cloud infrastructure system 902 may be owned by a third party cloud services provider and the cloud services are offered to any general public tenant, where the tenant can be an individual or an enterprise. In certain other aspects, under a private cloud model, cloud infrastructure system 902 may be operated within an organization (e.g., within an enterprise organization) and services provided to clients that are within the organization. For example, the clients may be various departments or employees or other individuals of departments of an enterprise such as the Human Resources department, the Payroll department, etc., or other individuals of the enterprise. In certain other aspects, under a community cloud model, the cloud infrastructure system 902 and the services provided may be shared by several organizations in a related community. Various other models such as hybrids of the above mentioned models may also be used.

Client computing devices 904, 906, and 908 may be of different types (such as devices 802, 804, 806, and 808 depicted in FIG. 8) and may be capable of operating one or more client applications. A user may use a client device to interact with cloud infrastructure system 902, such as to request a service provided by cloud infrastructure system 902.

In some aspects, the processing performed by cloud infrastructure system 902 for providing chatbot services may involve big data analysis. This analysis may involve using, analyzing, and manipulating large data sets to detect and visualize various trends, behaviors, relationships, etc. within the data. This analysis may be performed by one or more processors, possibly processing the data in parallel, performing simulations using the data, and the like. For example, big data analysis may be performed by cloud infrastructure system 902 for determining the intent of an utterance. The data used for this analysis may include structured data (e.g., data stored in a database or structured according to a structured model) and/or unstructured data (e.g., data blobs (binary large objects)).

As depicted in the embodiment in FIG. 9, cloud infrastructure system 902 may include infrastructure resources 930 that are utilized for facilitating the provision of various cloud services offered by cloud infrastructure system 902. Infrastructure resources 930 may include, for example, processing resources, storage or memory resources, networking resources, and the like.

In certain aspects, to facilitate efficient provisioning of these resources for supporting the various cloud services provided by cloud infrastructure system 902 for different tenants, the resources may be bundled into sets of resources or resource modules (also referred to as “pods”). Each resource module or pod may comprise a pre-integrated and optimized combination of resources of one or more types. In certain aspects, different pods may be pre-provisioned for different types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 902 may itself internally use services 932 that are shared by different components of cloud infrastructure system 902 and which facilitate the provisioning of services by cloud infrastructure system 902. These internal shared services may include, without limitation, a security and identity service, an integration service, an enterprise repository service, an enterprise manager service, a virus scanning and whitelist service, a high availability, backup and recovery service, service for enabling cloud support, an email service, a notification service, a file transfer service, and the like.

Cloud infrastructure system 902 may comprise multiple subsystems. These subsystems may be implemented in software, or hardware, or combinations thereof. As depicted in FIG. 9, the subsystems may include a user interface subsystem 912 that enables users of cloud infrastructure system 902 to interact with cloud infrastructure system 902. User interface subsystem 912 may include various different interfaces such as a web interface 914, an online store interface 916 where cloud services provided by cloud infrastructure system 902 are advertised and are purchasable by a consumer, and other interfaces 918. For example, a tenant may, using a client device, request (service request 934) one or more services provided by cloud infrastructure system 902 using one or more of interfaces 914, 916, and 918. For example, a tenant may access the online store, browse cloud services offered by cloud infrastructure system 902, and place a subscription order for one or more services offered by cloud infrastructure system 902 that the tenant wishes to subscribe to. The service request may include information identifying the tenant and one or more services that the tenant desires to subscribe to. For example, a tenant may place a subscription order for a chatbot related service offered by cloud infrastructure system 902. As part of the order, the client may provide information identifying the input (e.g. utterances).

In certain aspects, such as the embodiment depicted in FIG. 9, cloud infrastructure system 902 may comprise an order management subsystem (OMS) 920 that is configured to process the new order. As part of this processing, OMS 920 may be configured to: create an account for the tenant, if not done already; receive billing and/or accounting information from the tenant that is to be used for billing the tenant for providing the requested service to the tenant; verify the tenant information; upon verification, book the order for the tenant; and orchestrate various workflows to prepare the order for provisioning.

Once properly validated, OMS 920 may then invoke the order provisioning subsystem (OPS) 924 that is configured to provision resources for the order including processing, memory, and networking resources. The provisioning may include allocating resources for the order and configuring the resources to facilitate the service requested by the tenant order. The manner in which resources are provisioned for an order and the type of the provisioned resources may depend upon the type of cloud service that has been ordered by the tenant. For example, according to one workflow, OPS 924 may be configured to determine the particular cloud service being requested and identify a number of pods that may have been pre-configured for that particular cloud service. The number of pods that are allocated for an order may depend upon the size/amount/level/scope of the requested service. For example, the number of pods to be allocated may be determined based upon the number of users to be supported by the service, the duration of time for which the service is being requested, and the like. The allocated pods may then be customized for the particular requesting tenant for providing the requested service.

Cloud infrastructure system 902 may send a response or notification 944 to the requesting tenant to indicate when the requested service is now ready for use. In some instances, information (e.g., a link) may be sent to the tenant that enables the tenant to start using and availing the benefits of the requested services.

Cloud infrastructure system 902 may provide services to multiple tenants. For each tenant, cloud infrastructure system 902 is responsible for managing information related to one or more subscription orders received from the tenant, maintaining tenant data related to the orders, and providing the requested services to the tenant or clients of the tenant. Cloud infrastructure system 902 may also collect usage statistics regarding a tenant's use of subscribed services. For example, statistics may be collected for the amount of storage used, the amount of data transferred, the number of users, and the amount of system up time and system down time, and the like. This usage information may be used to bill the tenant. Billing may be done, for example, on a monthly cycle.

Cloud infrastructure system 902 may provide services to multiple tenants in parallel. Cloud infrastructure system 902 may store information for these tenants, including possibly proprietary information. In certain aspects, cloud infrastructure system 902 comprises an identity management subsystem (IMS) 928 that is configured to manage tenant's information and provide the separation of the managed information such that information related to one tenant is not accessible by another tenant. IMS 928 may be configured to provide various security-related services such as identity services, such as information access management, authentication and authorization services, services for managing tenant identities and roles and related capabilities, and the like.

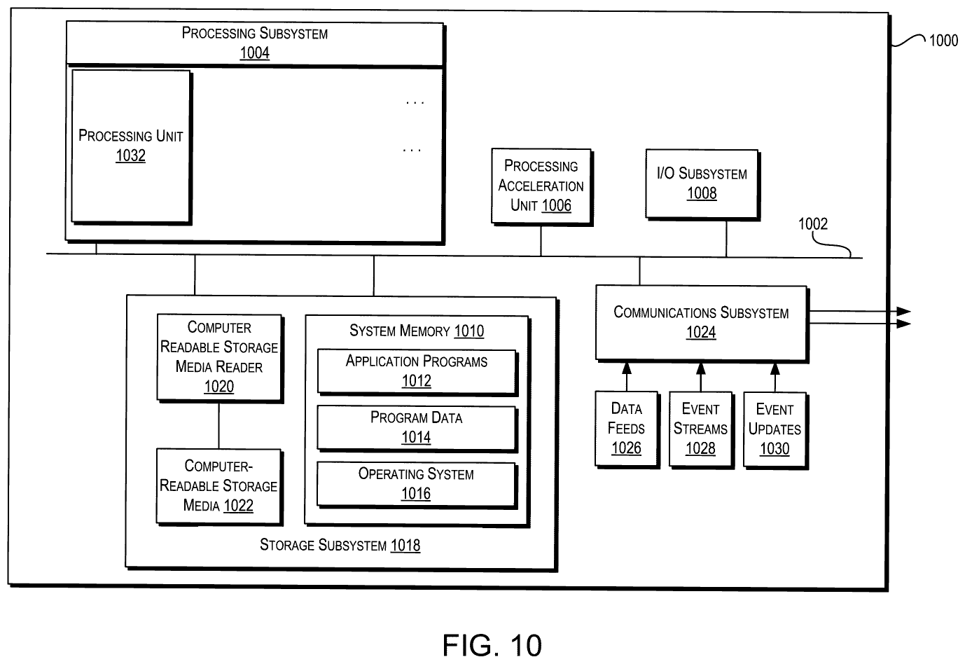

FIG. 10 illustrates an exemplary computer system 1000 that may be used to implement certain aspects. As shown in FIG. 10, computer system 1000 includes various subsystems including a processing subsystem 1004 that communicates with a number of other subsystems via a bus subsystem 1002. These other subsystems may include a processing acceleration unit 1006, an I/O subsystem 1008, a storage subsystem 1018, and a communications subsystem 1024. Storage subsystem 1018 may include non-transitory computer-readable storage media including storage media 1022 and a system memory 1010.

Bus subsystem 1002 provides a mechanism for letting the various components and subsystems of computer system 1000 communicate with each other as intended. Although bus subsystem 1002 is shown schematically as a single bus, alternative aspects of the bus subsystem may utilize multiple buses. Bus subsystem 1002 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard, and the like.

Processing subsystem 1004 controls the operation of computer system 1000 and may comprise one or more processors, application specific integrated circuits (ASICs), or field programmable gate arrays (FPGAs). The processors may be single core or multicore processors. The processing resources of computer system 1000 can be organized into one or more processing units 1032, 1034, etc. A processing unit may include one or more processors, one or more cores from the same or different processors, a combination of cores and processors, or other combinations of cores and processors. In some aspects, processing subsystem 1004 can include one or more special purpose co-processors such as graphics processors, digital signal processors (DSPs), or the like. In some aspects, some or all of the processing units of processing subsystem 1004 can be implemented using customized circuits, such as application specific integrated circuits (ASICs), or field programmable gate arrays (FPGAs).

In some aspects, the processing units in processing subsystem 1004 can execute instructions stored in system memory 1010 or on computer readable storage media 1022. In various aspects, the processing units can execute a variety of programs or code instructions and can maintain multiple concurrently executing programs or processes. At any given time, some or all of the program code to be executed can be resident in system memory 1010 and/or on computer-readable storage media 1022 including potentially on one or more storage devices. Through suitable programming, processing subsystem 1004 can provide various functionalities described above. In instances where computer system 1000 is executing one or more virtual machines, one or more processing units may be allocated to each virtual machine.

In certain aspects, a processing acceleration unit 1006 may optionally be provided for performing customized processing or for off-loading some of the processing performed by processing subsystem 1004 so as to accelerate the overall processing performed by computer system 1000.

I/O subsystem 1008 may include devices and mechanisms for inputting information to computer system 1000 and/or for outputting information from or via computer system 1000. In general, use of the term input device is intended to include all possible types of devices and mechanisms for inputting information to computer system 1000. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Meta Quest® controller, Microsoft Kinect® motion sensor, the Microsoft Xbox® 360 game controller, or devices that provide an interface for receiving input using gestures and spoken commands. User interface input devices may also include eye gesture recognition devices such as a blink detector that detects eye activity (e.g., “blinking” while taking pictures and/or making a menu selection) from users and transforms the eye gestures as inputs to an input device. Additionally, user interface input devices may include voice recognition sensing devices that enable users to interact with voice recognition systems (e.g., Siri® navigator or Amazon Alexa®) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, QR code readers, barcode readers, 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments, and the like.

In general, use of the term output device is intended to include all possible types of devices and mechanisms for outputting information from computer system 1000 to a user or other computer. User interface output devices may include a display subsystem, indicator lights, or non-visual displays such as audio output devices, etc. The display subsystem may be any device for outputting a digital picture. Example display devices include flat panel display devices such as those using a light emitting diode (LED) display, a liquid crystal display (LCD) or plasma display, a projection device, a touch screen, a desktop or laptop computer monitor, and the like. As another example, wearable display devices such as Meta Quest® or Microsoft HoloLens® may be mounted to the user for displaying information. User interface output devices may include, without limitation, a variety of display devices that visually convey text, graphics, and audio/video information such as monitors, printers, speakers, headphones, automotive navigation systems, plotters, voice output devices, and modems.

Storage subsystem 1018 provides a repository or data store for storing information and data that is used by computer system 1000. Storage subsystem 1018 provides a tangible non-transitory computer-readable storage medium for storing the basic programming and data constructs that provide the functionality of some aspects. Storage subsystem 1018 may store software (e.g., programs, code modules, instructions) that when executed by processing subsystem 1004 provides the functionality described above. The software may be executed by one or more processing units of processing subsystem 1004. Storage subsystem 1018 may also provide a repository for storing data used in accordance with the teachings of this disclosure.

Storage subsystem 1018 may include one or more non-transitory memory devices, including volatile and non-volatile memory devices. As shown in FIG. 10, storage subsystem 1018 includes a system memory 1010 and a computer-readable storage media 1022. System memory 1010 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 1000, such as during start-up, may typically be stored in the ROM. The RAM typically contains data and/or program modules that are presently being operated and executed by processing subsystem 1004. In some implementations, system memory 1010 may include multiple different types of memory, such as static random access memory (SRAM), dynamic random access memory (DRAM), and the like.

By way of example, and not limitation, as depicted in FIG. 10, system memory 1010 may load application programs 1012 that are being executed, which may include various applications such as Web browsers, mid-tier applications, relational database management systems (RDBMS), etc., program data 1014, and an operating system 1016. By way of example, operating system 1016 may include various versions of Microsoft Windows®, Apple Macintosh®, and/or Linux® operating systems, a variety of commercially-available UNIX® or UNIX-like operating systems (including without limitation the variety of GNU/Linux operating systems, the Oracle Linux®, Google Chrome® OS, and the like) and/or mobile operating systems such as iOS, Windows® Phone, Android® OS, and others.

Computer-readable storage media 1022 may store programming and data constructs that provide the functionality of some aspects. Computer-readable media 1022 may provide storage of computer-readable instructions, data structures, program modules, and other data for computer system 1000. Software (programs, code modules, instructions) that, when executed by processing subsystem 1004 provides the functionality described above, may be stored in storage subsystem 1018. By way of example, computer-readable storage media 1022 may include non-volatile memory such as a hard disk drive, a magnetic disk drive, an optical disk drive such as a CD ROM, digital video disc (DVD), a Blu-Ray® disk, or other optical media. Computer-readable storage media 1022 may include, but is not limited to, Zip® drives, flash memory cards, universal serial bus (USB) flash drives, secure digital (SD) cards, DVD disks, digital video tape, and the like. Computer-readable storage media 1022 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, dynamic random access memory (DRAM)-based SSDs, magnetoresistive RAM (MRAM) SSDs, and hybrid SSDs that use a combination of DRAM and flash memory based SSDs.

In certain aspects, storage subsystem 1018 may also include a computer-readable storage media reader 1020 that can further be connected to computer-readable storage media 1022. Reader 1020 may receive and be configured to read data from a memory device such as a disk, a flash drive, etc.

In certain aspects, computer system 1000 may support virtualization technologies, including but not limited to virtualization of processing and memory resources. For example, computer system 1000 may provide support for executing one or more virtual machines. In certain aspects, computer system 1000 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 1000. Accordingly, multiple operating systems may potentially be run concurrently by computer system 1000.

Communications subsystem 1024 provides an interface to other computer systems and networks. Communications subsystem 1024 serves as an interface for receiving data from and transmitting data to other systems from computer system 1000. For example, communications subsystem 1024 may enable computer system 1000 to establish a communication channel to one or more client devices via the Internet for receiving and sending information from and to the client devices. For example, the communications subsystem may be used to transmit a response to a user regarding the inquiry for a chatbot.

Communications subsystem 1024 may support both wired and/or wireless communication protocols. For example, in certain aspects, communications subsystem 1024 may include radio frequency (RF) transceiver components for accessing wireless voice and/or data networks (e.g., using cellular telephone technology, advanced data network technology, such as 3G, 4G or EDGE (enhanced data rates for global evolution), Wi-Fi (IEEE 802.XX family standards, or other mobile communication technologies, or any combination thereof), global positioning system (GPS) receiver components, and/or other components. In some aspects communications subsystem 1024 can provide wired network connectivity (e.g., Ethernet) in addition to or instead of a wireless interface.

Communications subsystem 1024 can receive and transmit data in various forms. For example, in some aspects, in addition to other forms, communications subsystem 1024 may receive input communications in the form of structured and/or unstructured data feeds 1026, event streams 1028, event updates 1030, and the like. For example, communications subsystem 1024 may be configured to receive (or send) data feeds 1026 in real-time from users of social media networks and/or other communication services such as Twitter® feeds, Facebook® updates, web feeds such as Rich Site Summary (RSS) feeds, and/or real-time updates from one or more third party information sources.

In certain aspects, communications subsystem 1024 may be configured to receive data in the form of continuous data streams, which may include event streams 1028 of real-time events and/or event updates 1030, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1024 may also be configured to communicate data from computer system 1000 to other computer systems or networks. The data may be communicated in various different forms such as structured and/or unstructured data feeds 1026, event streams 1028, event updates 1030, and the like to one or more databases that may be in communication with one or more streaming data source computers coupled to computer system 1000.

Computer system 1000 can be one of various types, including a handheld portable device (e.g., an iPhone® cellular phone, an iPad® computing tablet, a personal digital assistant (PDA)), a wearable device (e.g., a Meta Quest® head mounted display), a personal computer, a workstation, a mainframe, a kiosk, a server rack, or any other data processing system. Due to the ever-changing nature of computers and networks, the description of computer system 1000 depicted in FIG. 10 is intended only as a specific example. Many other configurations having more or fewer components than the system depicted in FIG. 10 are possible. Based on the disclosure and teachings provided herein, a person of ordinary skill in the art can appreciate other ways and/or methods to implement the various aspects.

Although specific aspects have been described, various modifications, alterations, alternative constructions, and equivalents are possible. Embodiments are not restricted to operation within certain specific data processing environments, but are free to operate within a plurality of data processing environments. Additionally, although certain aspects have been described using a particular series of transactions and steps, it should be apparent to those skilled in the art that this is not intended to be limiting. Although some flowcharts describe operations as a sequential process, many of the operations can be performed in parallel or concurrently. In addition, the order of the operations may be rearranged. A process may have additional steps not included in the figure. Various features and aspects of the above-described aspects may be used individually or jointly.

Further, while certain aspects have been described using a particular combination of hardware and software, it should be recognized that other combinations of hardware and software are also possible. Certain aspects may be implemented only in hardware, or only in software, or using combinations thereof. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Specific details are given in this disclosure to provide a thorough understanding of the aspects. However, aspects may be practiced without these specific details. For example, well-known circuits, processes, algorithms, structures, and techniques have been shown without unnecessary detail in order to avoid obscuring the aspects. This description provides example aspects only, and is not intended to limit the scope, applicability, or configuration of other aspects. Rather, the preceding description of the aspects can provide those skilled in the art with an enabling description for implementing various aspects. Various changes may be made in the function and arrangement of elements.

The specification and drawings are, accordingly, to be regarded in an illustrative rather than a restrictive sense. It can, however, be evident that additions, subtractions, deletions, and other modifications and changes may be made thereunto without departing from the broader spirit and scope as set forth in the claims. Thus, although specific aspects have been described, these are not intended to be limiting. Various modifications and equivalents are within the scope of the following claims.

What is claimed is:

1. A computer-implemented method comprising:
training a first machine learning model to predict a first type of member data for journal entries based on partial information for historical journal entries and a second machine learning model to predict a second type of member data for journal entries based at least in part on the first type of member data after the first type of member data has been determined;
accessing, from a data structure, a journal entry that records a particular partial information about an acknowledgement of an amount, wherein the particular partial information is missing a value for a first item of member data of the first type and missing a value for a second item of member data of the second type;
using the first machine learning model to automatically generate a first particular value for the first item of member data of the first type based at least in part on the partial information;
using the second machine learning model to automatically generate a second particular value for the second item of member data of the second type based at least in part on the first particular value and a confidence score for the first particular value;
persisting, as part of the journal entry in the data structure, the first particular value for the first item of member data and the second particular value for the second item of member data.

2. The computer-implemented method of claim 1, further comprising:
determining the confidence score using the first machine learning model based at least in part on previous predicted items of data and a record of whether the previous predicted items of data were accepted, wherein the confidence score is indicative of a likelihood of the first particular value being accepted.

3. The computer-implemented method of claim 2, wherein the determining the confidence score is further based on the amount associated with the acknowledgement.

4. The computer-implemented method of claim 2, further comprising:
updating the confidence score based at least in part on accepting the first particular value, rejecting the first particular value, or modifying one or more items of member data in the journal entry; and
using the second machine learning model to automatically update the second particular value based on the updated confidence score.

5. The computer-implemented method of claim 4, further comprising:
using the second machine learning model to automatically generate a third particular value for a third item of member data of the second type based at least in part on the updated confidence score.

6. The computer-implemented method of claim 1, further comprising:
causing display of a first graphical option to accept the first particular value for the first item of member data and a second graphical option to reject the first particular value for the first item of member data,
wherein the persisting the first particular value of the first item in the data structure as part of the journal entry is based on selection of the first graphical option to accept the first particular value.

7. The computer-implemented method of claim 1, further comprising:
causing display of a first graphical option to accept the second particular value for the second item of member data and a second graphical option to reject the second particular value for the second item of member data,
wherein the persisting the second particular value of the second item in the data structure as part of the journal entry is based on selection of the first graphical option to accept the second particular value.

8. A computer-program product comprising one or more non-transitory machine-readable storage media, including stored instructions configured to cause a computing system to perform a set of actions comprising:
training a first machine learning model to predict a first type of member data for journal entries based on partial information for historical journal entries and a second machine learning model to predict a second type of member data for journal entries based at least in part on the first type of member data after the first type of member data has been determined;
accessing, from a data structure, a journal entry that records a particular partial information about an acknowledgement of an amount, wherein the particular partial information is missing a value for a first item of member data of the first type and missing a value for a second item of member data of the second type;
using the first machine learning model to automatically generate a first particular value for the first item of member data of the first type based at least in part on the partial information;
using the second machine learning model to automatically generate a second particular value for the second item of member data of the second type based at least in part on the first particular value and a confidence score for the first particular value;
persisting, as part of the journal entry in the data structure, the first particular value for the first item of member data and the second particular value for the second item of member data.

9. The computer-program product of claim 8, the set of actions further comprising:
determining the confidence score using the first machine learning model based at least in part on previous predicted items of data and a record of whether the previous predicted items of data were accepted, wherein the confidence score is indicative of a likelihood of the first particular value being accepted.

10. The computer-program product of claim 9, wherein the determining the confidence score is further based on the amount associated with the acknowledgement.

11. The computer-program product of claim 9, the set of actions further comprising:
updating the confidence score based at least in part on accepting the first particular value, rejecting the first particular value, or modifying one or more items of member data in the journal entry; and
using the second machine learning model to automatically update the second particular value based on the updated confidence score.

12. The computer-program product of claim 11, the set of actions further comprising:
using the second machine learning model to automatically generate a third particular value for a third item of member data of the second type based at least in part on the updated confidence score.

13. A system comprising:
one or more processors;
one or more non-transitory computer-readable media storing instructions, which, when executed by the system, cause the system to perform a set of actions comprising:
training a first machine learning model to predict a first type of member data for journal entries based on partial information for historical journal entries and a second machine learning model to predict a second type of member data for journal entries based at least in part on the first type of member data after the first type of member data has been determined;
accessing, from a data structure, a journal entry that records a particular partial information about an acknowledgement of an amount, wherein the particular partial information is missing a value for a first item of member data of the first type and missing a value for a second item of member data of the second type;
using the first machine learning model to automatically generate a first particular value for the first item of member data of the first type based at least in part on the partial information;
using the second machine learning model to automatically generate a second particular value for the second item of member data of the second type based at least in part on the first particular value and a confidence score for the first particular value;
persisting, as part of the journal entry in the data structure, the first particular value for the first item of member data and the second particular value for the second item of member data.

14. The system of claim 13, the set of actions further comprising:
determining the confidence score using the first machine learning model based at least in part on previous predicted items of data and a record of whether the previous predicted items of data were accepted, wherein the confidence score is indicative of a likelihood of the first particular value being accepted.

15. The system of claim 14, wherein the determining the confidence score is further based on the amount associated with the acknowledgement.

16. The system of claim 13, the set of actions further comprising:
causing display of a first graphical option to accept the first particular value for the first item of member data and a second graphical option to reject the first particular value for the first item of member data,
wherein the persisting the first particular value of the first item in the data structure as part of the journal entry is based on selection of the first graphical option to accept the first particular value.

17. The system of claim 13, the set of actions further comprising:
causing display of a first graphical option to accept the second particular value for the second item of member data and a second graphical option to reject the second particular value for the second item of member data,
wherein the persisting the second particular value of the second item in the data structure as part of the journal entry is based on selection of the first graphical option to accept the second particular value.

18. A computer-implemented method comprising:
training a machine learning model to complete metadata of journal entries based on historical relationships between the metadata and partial information of the journal entries;
accessing, from a data structure, a particular journal entry that records an amount, one or more source entities relating to the amount, and one or more target entities relating to the amount;
using the machine learning model to automatically generate one or more items of metadata for the particular journal entry, the one or more items of metadata including a reviewer, an approver, or one or more categories of the particular journal entry;
causing concurrent display of one or more graphical representations of the one or more items of metadata, including a particular graphical representation of a particular item of metadata, using a different color than a base color used for one or more other graphical representations of the amount, the one or more source entities, or the one or more target entities;
causing display of a first graphical option to accept the particular item of the one or more items of metadata and a second graphical option to reject the particular item of the one or more items of metadata;
in response to selection of the first graphical option to accept the particular item, automatically persisting the particular item as part of the particular journal entry in the data structure, and automatically changing color of a particular graphical representation of the one or more graphical representations to the base color.

19. The computer-implemented method of claim 18, wherein the machine learning model is a first machine learning model, the method further comprising:
training a second machine learning model to predict member data for journal entries based at least in part on items of metadata; and
using the second machine learning model to automatically generate one or more values for one or more items of member data for the particular journal entry based at least in part on the particular item of metadata predicted using the first machine learning model and a confidence score for the particular item of metadata.

20. The computer-implemented method of claim 19, further comprising:
determining the confidence score based at least in part on a quantity of pending journal entries having a particular value for the approver, the reviewer, or the one or more categories.
